(19) United States
(12) Patent Application Publication
(10) Pub. No.: US 2023/0006214 A1
(43) Pub. Date: Jan. 5, 2023

(54) IDENTIFICATION AND METHODS OF FABRICATION OF NOVEL SCALABLE, ECONOMIC COMPLEX FRAMEWORK MATERIAL (CFM) BASED CATHODES FOR LITHIUM-SULFUR BATTERIES

(71) Applicant: UNIVERSITY OF PITTSBURGH - OF THE COMMONWEALTH SYSTEM OF HIGHER EDUCATION, PITTSBURGH, PA (US)

(72) Inventors: Prashant N. KUMTA, Pittsburgh, PA (US); Prasada Rao TALAKONDA, Farmington, MI (US); Moni Kanchan DATTA, Pittsburgh, PA (US); Oleg VELIKOKHATNYI, Pittsburgh, PA (US); Pavithra Murugavel SHANTHI, Pittsburgh, PA (US); Ramalinga KURUBA, Pittsburgh, PA (US)

(73) Assignee: UNIVERSITY OF PITTSBURGH - OF THE COMMONWEALTH SYSTEM OF HIGHER EDUCATION, PITTSBURGH, PA (US)

(21) Appl. No.: 17/781,061

(22) PCT Filed: Dec. 14, 2020
(86) PCT No.: PCT/US2020/064810

§ 371 Date: May 31, 2022

Related U.S. Application Data
(60) Provisional application No. 62/947,611, filed on Dec. 13, 2019.

(51) Int. Cl. H01M 4/66; H01M 50/46; H01M 4/38; H01M 4/58; H01M 10/647; H01M 10/052

(52) U.S. Cl. CPC H01M 4/663; H01M 50/46; H01M 4/382; H01M 4/5815; H01M 10/647; H01M 10/052; H01M 2004/028

(57) ABSTRACT

The invention relates to complex framework materials (CFMs) for lithium-sulfur batteries. The CFMs include a CFM host and a coating applied to the CFM host, which includes one or more of an electronic conductor, a lithium ion conductor and a functional catalyst. Further, sulfur is infiltrated into the CFM host creating a sulfur-carbon linkage serving as effective anchors for trapping polysulfides. The systems have been tested in coin cells and pouch cells under lean electrolyte conditions of 3-4 μl/mg of electrolyte to sulfur ratios showing promise and feasibility.

### CROSS-REFERENCE TO RELATED APPLICATIONS

This application claims priority under 35 U.S.C. § 119(e) from U.S. provisional patent application No. 62/947,611, entitled “IDENTIFICATION AND METHODS OF FABRICATION OF NOVEL SCALABLE, ECONOMIC COMPLEX FRAMEWORK MATERIAL (CFM) BASED CATHODES FOR LITHIUM-SULFUR BATTERIES” and filed on Dec. 13, 2019, the contents of which are incorporated herein by reference.

### GOVERNMENT FUNDING

This invention was made with government support under DE-EE0008199 and DE-EE0006825 awarded by the Department of Energy. The government has certain rights in the invention.

### Field of the Invention

The invention relates to economic and scalable complex framework materials (CFMs) for use as polysulfide confining structures in lithium-sulfur (Li—S) batteries.

### BACKGROUND OF THE INVENTION

Development in portable electronic devices (PEDs) including laptops, camcorders, mobile phones, and portable digital assistants as well as electric vehicles (EVs), is largely limited by the gravimetric and volumetric energy densities of the Li-ion battery systems (Wh/kg and Wh/L). Improvements in energy density are therefore imperative to exploit the complete potential of these novel environmentally benign technologies. Li—S battery systems uses sulfur which has a theoretical specific capacity of 1675 mAh/g¹ as cathode and exhibits a thermodynamic specific energy density of 2600 Wh/kg².

Lithium-sulfur battery (LSB) technology is widely investigated as an attractive alternative to currently used Li-ion battery (LIB) chemistries for the PED/EV industry, due to the superior theoretical capacity and specific energy density of elemental sulfur.

Furthermore, the natural abundance of sulfur in the earth's crust makes it a more economical and highly attractive proposition compared to currently existing intercalation-based LIB cathode material systems. Lithium-Sulfur (Li—S) batteries have the potential to meet the increased energy density requirements of electric vehicle (EV) technologies. However, the Li—S system is plagued by deleterious polysulfide shuttling. Furthermore, there are limitations associated with the LSB technology including the dissolution of sulfur via formation of soluble polysulfides (i.e., poor capacity retention) and inferior electronic conductivity of sulfur (barrier to complete active materials utilization). Current generation, sulfur cathodes exhibit low reversible specific storage capacity, poor charging rates and low loading densities.

Various strategies have been explored to address these challenges. Conductive carbon was introduced into the sulfur cathodes to increase the conductivity and active material utilization of the electrodes, with overall reduction in cathode resistance by high conductivity carbon black incorporation in the active material mixture. The active carbon possesses nanopores (˜2-10 nm) with a high surface area (˜500-2000 m²/g) absorbing the polysulfide species thereby preventing their dissolution into the electrolyte. Mesoporous carbon acts as an ordered encapsulation substrate for sulfur. There has been systematically tuned and investigated the pore sizes and pore volumes of several mesoporous carbon materials and showed that the large pore size (˜3-22 nm) of mesoporous carbon can accommodate higher sulfur loading (>80% S) and can exhibit enhanced cell performance under higher sulfur loading situations. Transition metal silicates, aluminum oxides, vanadium oxides, and transition-metal chalcogenides have been utilized with sulfur cathodes to decrease the polysulfide diffusion and migration. However, their electron transport property was limited by large particle size that tend to decrease the electrochemical performance. In addition to limitations in sulfur cathodes, the lithium anode side is also plagued with limitations of dendrite formation posing a safety hazard. Replacing the commonly used Li—S battery organic electrolyte (dioxolane(DOL)/dimethoxyeethane(DME)) with a PVdF-HFP based composite polymer electrolyte (CPE) has shown ability to trap the polysulfides due to the very low electrolyte content of the CPE (˜1-2 μl electrolyte/mg sulfur). The safety and cyclic life of the anode was improved using polymer and solid-state electrolytes that protect lithium metal and minimize dendrite formation on the anode, hence leading to enhanced performance of Li—S batteries. Nevertheless, polymer and solid-state electrolytes generally suffer from low Li-ion conductivity due to the high viscous nature of polymers hindering the lithium ion transport due to high energy barrier in solid state electrolytes as well as the ceramic nature of the solid state electrolytes requiring high activation energy for Li-ion diffusion. These approaches however, lead to an increase in the utilization of active material in sulfur cathodes although, they lack complete prevention of the dissolution of polysulfide species into the electrolyte.

Thus, there is a need for the design and development of CFM-based cathodes to enable batteries with higher energy density and decreased capacity fade properties. Successful implementation of CFM-based sulfur cathodes in lithium-ion batteries would expedite the development of high energy density batteries.

### SUMMARY OF THE INVENTION

In one aspect, the invention provides a complex framework material structure including a complex framework material host, which includes a complex framework material and a coating applied to the complex framework material including one or more layers that include a component selected from the group consisting of an electronic conductor, a lithium ion conductor and a functional catalyst.

In certain embodiments, the complex framework material comprises a porous carbon matrix. The complex framework material may comprise Super P, a highly porous high surface area, from about 2000 to about 3000 m²/g, YP-80F or mixtures thereof.

The complex framework material structure may be selected from an EC-CFM (coated with an electronic conductor), a LIC-CFM (coated with a lithium ion conductor termed as LiOPAN), and a FC-CFM (coated with a functional catalyst).

The coating may be a single layer including a component selected from the group consisting of an electrical conductor, a lithium ion conductor and a functional catalyst. Alternatively, the coating may be a multi-layer coating and each layer may include a component selected from the group consisting of an electronic conductor, a lithium ion conductor and a functional catalyst

In certain embodiments, sulfur is infiltrated into the complex framework material host to produce an EC-CFM-S, a LIC-CFM-S and a FC-CFM-S electrode. The sulfur loading is from 8 to 18 mg/cm².

In another aspect, the invention provides a complex framework material-based cathode, and a lithium-sulfur (Li—S) battery including the complex framework material-based cathode. Further, the complex framework material-based cathode includes the foregoing complex framework material structure.

In still another aspect, the invention provides a method of preparing a complex framework material structure. The method includes forming a complex framework material host that includes providing a complex framework material; applying a coating to the complex framework material comprising one or more components selected from the group consisting of an electronic conductor, a lithium ion conductor and a functional catalyst; and infiltrating the complex framework material host with sulfur.

In yet another aspect of the invention, a pouch cell is provided that includes a complex framework material/sulfur composite cathode, which includes a complex framework material host, including a complex framework material; and a coating applied to the complex framework material comprising one or more layers comprising a component selected from the group consisting of an electronic conductor, a lithium ion conductor and a functional catalyst; and sulfur infiltrated into the complex framework material host; a separator applied to the complex framework material/sulfur composite cathode; and a lithium anode applied to the separator, wherein, the composite complex framework material/sulfur cathode, the separator and the lithium anode are in a stacked configuration.

The complex framework material may be comprised of a porous carbon matrix. In certain embodiments, the complex framework material comprises Super P, YP-80F or mixtures thereof, to bind polysulfide via carbon-sulfur linkages.

The pouch cell can include a single layer of each of the complex framework material/sulfur cathode and the lithium anode. Alternatively, the pouch cell can include two or more layers of each of the complex framework material/sulfur cathode and the lithium anode.

### BRIEF DESCRIPTION OF THE DRAWINGS

FIG. 1 is a plot that shows cycling performance of LIC-CFM-S cycled at 0.1 C rate, in accordance with certain embodiments of the invention;

FIG. 2 is a plot that shows a single layer Li—S pouch cell using sulfurized LiOPAN coated Super P: Sulfur composite as the S cathode with a sulfur loading of 6.26 mg/cm²; in accordance with certain embodiments of the invention;

FIGS. 3a and 3b are plots that show cycling and energy density of single layer Li—S pouch cell using sulfurized LiOPAN coated Super P:Sulfur composite as the S cathode with S loading of 6.26 mg/cm², in accordance with certain embodiments of the invention;

FIG. 4 is a plot that shows single layer Li—S pouch cell with sulfurized LiOPAN coated Super P: Sulfur composite as S cathode with sulfur loading of 4.59 mg/cm², in accordance with certain embodiments of the invention;

FIGS. 5a and 5b are plots that show cycling and energy density of single layer Li—S pouch cell with sulfurized LiOPAN coated Super P:Sulfur composite as the sulfur cathode with the sulfur loading of 4.59 mg/cm², in accordance with certain embodiments of the invention;

FIG. 6 is a plot that shows two-layer pouch cell cycling data with sulfurized LiOPAN coated Super P: Sulfur composite as S cathode with a sulfur loading of 6 mg/cm², in accordance with certain embodiments of the invention;

FIG. 7 is a plot that shows four-layer pouch cell cycling data with sulfurized LiOPAN coated Super P: Sulfur composite as S cathode with sulfur loading of 4.72 mg/cm², in accordance with certain embodiments of the invention;

FIG. 8 is a plot that shows pouch cell cycling data with sulfurized PAN coated YP-80F: Sulfur composite as S cathode, in accordance with certain embodiments of the invention;

FIG. 9 is a plot that shows pouch cell cycling data with sulfurized LiOPAN coated YP-80F: Sulfur composite as S cathode with calendaring with sulfur loading of 4.8 mg/cm², in accordance with certain embodiments of the invention;

FIG. 10 is a plot that shows cyclic voltammetry (CV) results showing plating and de-plating of Li metal studied on cell: Li metal∥Hybrid Solid Electrolyte (HSE) coating+liquid electrolyte∥Cu metal, in accordance with certain embodiments of the invention;

FIGS. 11a and 11b are plots that show 2032 coin cell data: (a) HSE coated separator and added liquid electrolyte, (b) with only liquid electrolyte, in accordance with certain embodiments of the invention; and

FIG. 12 is a plot that shows 2032 coin cell data comparing the initial cycling results of the cell containing the HSE coated separator versus the cell cycled using only the liquid electrolyte of 4 μl/mg, in accordance with certain embodiments of the invention.

### DETAILED DESCRIPTION OF THE INVENTION

The invention relates to novel, complex framework materials (CFMs) and CFM-based structures/architectures that include one or more of a CFM host for sulfur infiltration, a coating that includes an electronic conductor (EC), a lithium ion conductor (LIC) and/or a functional catalyst (FC). The invention includes the development of CFMs, which enable chemical binding of polysulfides and catalytic promoters for polysulfide conversion. The CFMs reduce or preclude, e.g, completely, polysulfide dissolution into an electrolyte of a battery. The CFM-based architectures are used to form cathodes for use in lithium-sulfur batteries.

The invention includes novel high sulfur loading, directly doped sulfur architecture (DDSA), binder-free cathodes and unique polysulfide trapping agent (PTA) configurations, novel inorganic framework materials (IFM) enabling high sulfur loading and polysulfide (PS) confinement, organic complex framework materials (CFMs) serving as improved sulfur hosts using wet-chemical methods, high Li-ion conducting (LIC) and PS dissolution resistant coatings on sulfur nanoparticles, and functional catalysts (FCs) determined by Density Functional Theory (DFT) or first principles theoretical calculations for rapid conversion of PS to Li₂S and Li₂S to Li and S.

The invention provides high throughput, high yield, scalable and commercially inexpensive processes for synthesis of electro-chemically stable sulfur-based cathode materials/architectures.

Suitable CFMs for use in the invention include high surface area and high pore volume organic and inorganic materials, such as, a porous carbon matrix, and any highly porous high surface area, e.g., from about 2000 to about 3000 m²/g, YP-80F, and mixtures thereof, with the ability to bind polysulfide via carbon-sulfur linkages. In certain embodiments, the CFMs include but are not limited to carbon black (Super-P) to form carbon black (Super-P)-based CFM hosts. Suitable electronic conductors (ECs) for use in the invention include nitrogen or sulfur or phosphorus containing carbon backbone based aromatic or aliphatic ring polymers such as pyrolyzed form of poly acrylonitrile (PAN), polythiophene, polyaniline and the like. Suitable lithium ion conductors (LICs) include Li-salt reacted with PAN to form LiOPAN as well as other S, P and N containing polymers. Suitable functional catalysts (FC) include one or more of a transition metal oxide, nitride, sulfide, boride, selenide, telluride, phosphide, bismuthides, antimonide and arsenide, as well as any transition metal-containing non-oxide with an ability to bind negatively charged polysulfide species to form FC-CFM. The FC converts polysulfides to Li₂S, and Li₂S to Li and S, respectively.

In certain embodiments, a single coating or layer of EC or LIC or FC is applied to the CFM, e.g., porous carbon matrix. In certain other embodiments, more than one coating or layer, e.g., a multilayer, of EC and/or LIC and/or FC or a combination thereof, is each separately and individually applied to the CFM, e.g., porous carbon matrix. The coated CFMs, for example, include EC-CFM, LIC-CFM, and FC-CFM nanocrystalline, porous architectures. Sulfur is then infiltrated into the CFM to form EC-CFM-S, LIC-CFM-S, and FC-CFM-S nanocrystalline, porous architectures. In certain embodiments, the nanocrystalline porous architectures include porous carbon structures. The porosity of the architectures varies and, in certain embodiments, the porosity is from 10 to 90 percent or from 50 to 60 percent. The EC-CFM-S, LIC-CFM-S and FC-CFM-S architectures include sulfur particles within at least a portion of the pores of the porous carbon structures. In certain embodiments, the sulfur loading of the CFM architectures is from 8 to 18 mg/cm².

In certain embodiments, the coated EC-CFM, LIC-CFM, and FC-CFM nanocrystalline, porous architectures are doped. A dopant, such as a nanostructured dopant, is added to the coating. In other embodiments, the coated EC-CFM, LIC-CFM, and FC-CFM nanocrystalline, porous architectures are undoped. Various conventional/traditional doping techniques are known in the art. In certain embodiments, using suitable doping techniques, such as a facile solid diffusion technique, a dopant is employed to interact with the LIC and/or EC coating. Suitable dopants include Ti, Au, Ag, Al, Mg, Ca, F, Nb, B, V, N, P, S, Se, Te, Mn, Sn, Bi, Ni, Co, Fe or any element from the transition metal series or Group IIIA, IVA, VA, VIA and VIIA, and the like.

The CFM host in the absence of the aforementioned coating(s) exhibits poor electrical conductivity, low surface area and pore volume, as well as low and higher order polysulfides. Whereas, the CFMs having the aforementioned EC coating(s) exhibit one or more of improved electrical conductivity, high surface area and pore volume, as well as reduced polysulfide dissolution and high areal capacity. The EC-CFM-S demonstrates an ability to trap the polysulfide, thereby improving the areal capacity. The LIC-CFM-S having the aforementioned LIC coating(s) exhibits one or more of improved ionic conductivity, high surface area and pore volume, as well as high areal capacity. The FC-CFM-S having the aforementioned FC coating(s) exhibits one or more of high surface area and pore volume, as well as a reduction or prevention of polysulfide dissolution and high areal capacity. All of these CFM systems have inherent polysulfide trapping agent (PTA) configurations, and hence, they demonstrate an improvement for confining polysulfide species, and the ability to accommodate high sulfur loadings.

In certain embodiments, the CFM structure/architecture has an LIC coating deposited on a high surface area CFM (LIC-HCFM), wherein sulfur is infiltrated into the CFM to form a LIC-HCFM-S nanocrystalline, porous architecture.

The electronic conductor (EC) and lithium ion conductor (LIC) are prepared using conventional wet chemical and low temperature synthesis approaches. The ECs and LICs used to coat the CFMs exhibit high electronic conductivities (>10⁻³ S/cm) and room temperature lithium ion conductivities (>10⁻⁴ S/cm), respectively. The porous metal oxide and non-oxide functional catalyst (FC) (>150 m²/g) capable of catalyzing the polysulfide reduction and oxidation are generated using a simple room-temperature method. In certain embodiments, the oxide and non-oxide functional catalysts (FC) are prepared using dry and wet chemical methods. The EC-CFM, LIC-CFM and FC-CFM are then infiltrated with sulfur using low-temperature under vacuum/inert conditions to form EC-CFM-S, LIC-CFM-S and FC-CFM-S. These EC-CFM-S, LIC-CFM-S and FC-CFM-S architectures exhibit a strong binding between the carbon atoms from the CFM hosts and the sulfur molecules forming —C—S— bonds. The creation of these —C—S— bonds inhibits polysulfide dissolution by binding them, as is evident from XPS analysis of the sulfur infiltrated CFMs.

Lithium-sulfur cathodes according to the invention consist of a uniquely designed CFM coated with a Li-ion conductor to form LIC-CFM. The LIC-CFM includes one or more porous carbon-based materials coated with a novel nitrogen containing hydrocarbon or carbonaceous polymer such as polyacrylonitride (PAN) modified by reaction with LiNO₃ resulting in a Li-ion conducting coating (LiOPAN) combined with elemental sulfur (S). The composite LIC-CFM containing sulfur cathode is suitable for use as a stable, high cycle life and high capacity cathode for lithium-sulfur (Li—S) batteries.

The PAN polymer on the surface of the porous carbon based CFM is pyrolyzed, e.g., in argon gas at a temperature of 240° C., in the presence of LiNO₃ and elemental sulfur (S), which leads to the formation of a cyclized PAN polymer network with structural changes including Li-ions attached to the carbon and nitrogen backbone on the surface of porous carbon matrix to form a LiOPAN coating. In certain embodiments, the entire synthesis of the cyclized PAN and LiNO₃ to form LiOPAN and all the chemical reactions are executed inside a sealed swagelok container containing a dry mixture of the composite materials. Two major changes that occur simultaneously during PAN pyrolysis process on the surface of porous carbon matrix are the following: (i) PAN converting into N-type PAN, namely, nitrogen doped PAN (N-type PAN) forming LiOPAN after decomposition of LiNO₃, (ii) N-type LiOPAN converting into sulfurized PAN with long-range N-type bonds, the N-type PAN undergoes sulfurization, e.g., at a temperature of 240° C., and it is in turn, transformed into sulfurized PAN due to a cyclization reaction, which creates conjugated polymer structure with long-range N-type bonds. Hence, the LiOPAN coated porous carbon matrix is converted to sulfurized LiOPAN coating on porous carbon matrix and the sulfurized LiOPAN coating also further develops cross-linked networks on the surface and within the bulk of the porous carbon matrix. In addition, the heat treatment, e.g., at a temperature of 240° C., results in the creation of carbon-sulfur linkages leading to trapping of ensuing polysulfide species formed during the reaction with Li-ions when cycled in the Li—S battery. Thus, the sulfurized LiOPAN coating serves to effectively trap polysulfides while also serving as Li-ion conducting channels with the electron conducting coatings and the FCs together providing electron transport and catalytic features enabling conversion of polysulfides to Li₂S and back to Li and S.

These C—S linkages are formed with the sulfur within the pores and on the surface of the porous carbon matrix filled with vaporized sulfur during vapor phase sulfur infiltration. Hence, the final product of S cathode composite material consists of a uniform electrically conductive network of sulfurized PAN as well as Li-ion reacted with PAN to form LiOPAN on the surface and within the pores of the porous carbon matrix already filled with nano-sized sulfur. The novel LiOPAN coated CFM-S cathode provides S cathode stability, high capacity and cycle life improvements due to the synergetic effect of sulfurized PAN network on porous carbon matrix. The sulfurized LiOPAN coated porous carbon-based S cathode composite material can also be synthesized in large-scale (few kilograms per batch, depending on the size of the swagelok container). The production is also possible with low cost using vapor phase sulfur infiltration method. Commercial porous carbon materials used as porous carbon matrix for PAN coating and sulfur infiltration comprise Super P with surface area ≈62 m²/g (Timcal super P), activated carbon with surface area ≈2004 m²/g (YP-80F, Kuraray coal) and a mixture of Super P and YP-80F.

In certain embodiments, fabrication of crack free electrodes with targeted porosity (˜50-60%) and a target sulfur loading of (˜4-6 mg/cm²) of sulfur cathode are provided to facilitate and achieve efficient charge transport in the electrode. Attainment of crack free S cathode is critical and needed to improve the S utilization rate and confer cycling stability of the assembled Li—S cell.

According to the invention, slurry coatings and 3D-printed (3DP) architectures are also used to form the cathodes. The slurry coatings are produced using conventional slurry coating methods. The 3D-printed architectures of the CFMs, e.g., EC-CFM-S, LIC-CFM-S and FC-CFM-S, are produced by conventional 3D-printing techniques to form the CFM-based cathodes. A composite polymer electrolyte (CPE) membrane replaces liquid electrolyte (e.g, CPE as electrolyte). In certain embodiments, a lithium anode (+), CPE and sulfur cathode (+) form a stacked configuration. The CPE is positioned (e.g., sandwiched) between the lithium anode and the sulfur cathode. In accordance with the invention, the inventors have found for 3DP-LIC-CFM-S of nanocrystalline porous architecture with CPE, for which the CPE has very low electrolyte (E)/sulfur (S) ratio and the 3DP-LIC-CFM-S separator has no polysulfide dissolution after cycling, as well as exhibiting very high areal capacity. The CFM-based cathodes of the invention within a lithium ion battery provide a lithium-sulfur battery system with enhanced performance and properties.

In certain embodiments, a pouch cell is fabricated as follows. A single-sided Li foil is applied, e.g., calendered, onto a Cu foil as the Li anode for the single layer pouch cell. The separator for the pouch cell is a battery separator membrane or film, such as, but not limited to Celgard 2400. The single-sided CFM-S based cathode, separator, and single-sided Li anode are arranged in a stacked configuration, such that the separator is “sandwiched” between the S cathode and the Li anode, as the single layer pouch cell. In certain other embodiments, a multi-layer pouch cell is fabricated. A double-sided Li foil is applied, e.g., calendered, onto a Cu foil as the Li anode of a pouch cell. A double-sided CFM-S based cathode, separator, and double-sided Li anode are stacked together with two pieces or layers of the single-sided CFM-S based cathode as the outer layer for the multi-layer pouch cells. An electrolyte, such as, but not limited to LiTFSI, is used. The electrolyte injection and pouch cell sealing are carried out, such as, in a glovebox.

In certain embodiment, the CFM architectures are tested in coin cells and pouch cells under lean electrolyte conditions of 3-4 μl/mg of electrolyte (E) to sulfur (S) ratios showing feasibility.

In certain embodiments, the LIC-CFM-S is prepared by mixing the LIC-CFM and sulfur in a weight ratio from 10:90 to 20:80.

Hybrid composite solid polymer electrolytes (HSE) are synthesized by mixing sulfur, CFM and functional monomer in a weight ratio from 70:20:10 to 80:10:10, to yield sulfur rich-CFM with sulfur polymer (S-CFM).

In certain embodiments, CFM-S is prepared using a synthetic polymer binder (SPB) to produce a cathode. The CFM-S material is synthesized using a vapor phase infiltration method. This CFM-S has the ability to trap polysulfide ions, hence SPB improves the cell performance. The CFM-S system enhances polysulfide trapping, and increases sulfur utilization with optimal porosity.

In other embodiments, an inorganic framework material (IFM) is mixed with sulfur in a ratio from 10:90 to 20:80. The IFM-S system is synthesized using a vapor phase infiltration method.

Bifunctional-catalyst (BC) cathode materials are synthesized by mixing polymer, IFM and catalyst in a ratio of 90:4:3:3 with ball milling to produce a BCCM-S system.

The CFMs are tested in prismatic pouch cells against lithium metal anode using organic liquid electrolyte.

It is contemplated and expected that materials and approaches of the invention are not limited to the particular materials described herein and are applicable and extendable to include a wide variety of high specific surface area and high pore volume organic and inorganic CFM materials for confining sulfur and the generated polysulfides.

The CFMs of the invention provide one or more unique features as compared to known materials, such as very high lithium ion conductivity and electronic conductivity, high specific surface area and pore volume, polysulfide binding and trapping properties, very low fade rate cycling on account of prevention of polysulfide dissolution in Li—S batteries, and high sulfur loading and lean electrolyte (electrolyte (E)/sulfur (S)) testing properties.

The invention addresses disadvantages associated with known battery systems, including (a) low overall electrode capacity (mAh/g-active material) occurring due to low electronic conductivity of sulfur, (b) poor cycling stability owing to polysulfide (PS) dissolution, (c) voltage drop due to PS transport across and the deposition at the lithium anode, and (d) poor Coulombic efficiency (CE). Thus, the invention delivers either lithium metal/sulfur cells or lithium/[Nickel (N)-Manganese (M)-Cobalt (C) oxide (NMC)] cells exhibiting good energy density (e.g., in excess of 500 Wh/kg) and stable cycling (e.g., over 1000 cycles). The invention includes polysulfide confinement, sulfur electrocatalyst (SEC), directly derived sulfur assembled (DDSA) electrodes of electronically conducting nanostructured doped sulfur. In certain embodiments, the invention yields high sulfur loadings >10 mg/cm² and sulfur cathodes displaying specific capacity ≥1200 mAh/g electrode-level capacity, at ≥2.2V generating ˜600 Wh/kg and energy density systems. Full cells are constructed and performance tested in pouch cells. The results include (a) targeted lithium-sulfur battery (LSB) specific energy (≥500 Wh/kg) and energy density (≥750 Wh/1), (b) compact light-weight LSB, (c) economical and scalable precursors, and (d) excellent life-cycle (˜1000 cycle), calendar life (˜15years) and fast recharge-ability. Further, in accordance with the invention, full cells with optimized sulfur cathodes and dendrite-free lithium metal anodes (LMA) are generated with the following performance metrics: specific energy >500 Wh/kg, cyclability (>1000 cycles), loss per cycle <0.01%, Coulombic efficiency (CE): >90% capable of meeting MIL-STD-810G and IEC62133 industry safety standards.

The EC-CFM-S and LIC-CFM-S architectures exhibit polysulfide confinement. Due to the unique polysulfide confinement property of the EC-CFM-S and LIC-CFM-S, a significantly improved electrochemical cycling performance is observed in both coin-cell and pouch-cell configurations when tested using the Department of Energy's (DOE) Battery 500 protocol to test sulfur cathodes (>4 mg/cm2 S loading, >4 mAh/cm2 areal capacity, >64% electrode sulfur content and 4 μl/mg-S electrolyte to sulfur (E/S) ratio). The EC-CFM-S systems, upon testing at ˜5.6 mg/cm² sulfur loadings, show areal capacities of 3.4 mAh/cm² when cycled at C/10 rate under Battery 500 lean electrolyte testing conditions (4 μl/mg-S). The LIC-CFM-S system show ˜4.3 mAh/g capacity for over 100 cycles (˜6 mg/cm²) when tested under Battery 500 lean electrolyte conditions (4 μl/mg).

Further, the FC-CFM-S architectures, upon testing at ˜6.4 mg/cm² loadings, show areal capacities of ˜4.3 mAh/cm² when cycled at C/10 rate under Battery 500 lean electrolyte conditions (4 μl/mg). The 3DP-LIC-CFM electrodes with a sulfur loading of ˜8 mg/cm² show high areal capacities of ˜4.8 mAh/cm².

Initial pouch cell testing of the LIC-CFM-S system shows specific capacities (˜450 mAh/g) at ˜2.4 mg/cm² loadings and under E/S ratio (10 μl/mg).

The CFM architectures according to the invention confine polysulfide species with high S loadings (˜6 mg/cm2) and areal capacity ˜4 mAh/cm² under lean electrolyte (4 μl/mg-10 μl/mg) conditions. These CMF-based nanocrystalline (˜10 nm) polysulfide confinement structures are cost-effective and easily scalable, sulfur host structures for Li—S batteries with high energy density.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof

### EXAMPLES

### Example 1

The Examples include the (i) generation of novel high sulfur loading directly doped sulfur architecture (DDSA) binder-free cathodes and unique polysulfide trapping agent (PTA) configurations (S1), (ii) generation of novel inorganic framework materials (IFM) enabling high sulfur loading and polysulfide (PS) confinement (S2), (iii) development of organic complex framework materials (CFMs) serving as improved sulfur hosts using wet-chemical methods (S3), (iv) generation of high Li-ion conducting (LIC) and PS dissolution resistant coatings on sulfur nanoparticles, and (v) identification of functional catalysts (FCs) for rapid conversion of PS to Li₂S and Li₂S to Li and S, respectively.

Identification and synthesis of functional catalysts (FCs) for rapid conversion of polysulfides (PS) to lithium disulfide was performed as well as optimization of the high loading directly doped sulfur architecture (DDSA) electrodes.

To accelerate the polysfide (PS) conversion forward to Li₂S and backward to form pure Li and S, functional catalysts (FC) materials were identified to facilitate both, the forward and backward reactions (Reactions 1 and 2) (Equation 1) and correspondingly, significantly decrease or even completely eliminate the PS dissolution. Several compounds as functional catalysts (FCs) were used.

(Reaction 1) (Reaction 2)

2Li⁺+2e−+(m/8) S₈⇄Li₂Sₘ⇄Li₂S+[(m−1)/8]S₈, m=1,2,3, . . . , 8 (Equation 1)

The decomposition energy ΔG of various PSs is different for different FCs. The FCs were evaluated experimentally.

Electrochemical testing of PTA coated DDSA electrodes was conducted using the Batt 500 protocol (lean electrolyte-3 μl/mg S). Both forms of the DDSA electrodes, PTA-DDSA-1 and PTA-DDSA-2 electrodes showed an initial capacity of 1263 mAh/g and 1326 mAh/g respectively, when cycled at C/20 rate. Upon prolonged cycling, both PTA-DDSA-1 and PTA-DDSA-2 showed a capacity of 1023 mAh/g and 986 mAh/g respectively after 100 cycles at C/5 rate.

An electrochemical performance study was performed of doped lithium ion conductors (LICs) and their polysulfide shielding properties. The doped and undoped LICs coated thick nano sulfur pelletized electrodes (˜7.5 mg-S/cm²) were tested in a Li—S battery and the changes in the charge transfer resistance (R_{ct}) before cycling at open circuit potential was analyzed by electrochemical impedance spectroscopy (EIS). EIS tests showed a steady Rct decrease for the LIC coated electrodes with dopant additions due to higher lithium ion conductivity of the doped LICs contrasted with undoped LIC predicted by DFT calculations. Doped and undoped LIC coated S electrodes were then cycled at a charge and discharge rate of 0.2 C for 100 cycles to assess the influence of the dopants on the cycle life. Cycling results showed improved cycling stability for the doped LIC coated electrodes compared to undoped LIC coated electrodes. A doped LIC in fact, yielded a capacity of 553 mAh/g while undoped LIC displayed only 247 mAh/g after 100 cycles. These initial results reveal the ability of the doped LICs to improve the sulfur cathodes cycling stability by decreasing the interface impedance, and also anchoring the polysulfides from entering the electrolyte.

Sulfur infiltrated sulfur-copper-bipyridine derived complex framework material (S—Cu-bpy-CFM) were evaluated for their performance as cathodes. Correspondingly, the doped and undoped LICs coated on S—Cu-bpy-CFM pellet electrodes (˜3.8 mg-S/cm²) were tested in coin cells with Li metal in lean (˜3 μl/mg) electrolyte conditions.

The effect of doping on cycling stability of the S—Cu-bpy-CFM cathodes cycled at 100 mA/g current and rate capability were evaluated by comparing the cycling of doped and undoped LIC coated S—Cu-bpy-CFM cathodes. Undoped LIC coated S—Cu-bpy-CFM cathodes displayed an initial capacity of 873 mAh/g and a stable capacity of 583 mAh/g after 100 cycles. The doped LIC coated S—Cu-bpy-CFM cathodes on the other hand, showed much better cycling and rate capability due to higher Li-ion conductivity of the doped LICs. Electrodes with D1 (Ca) doped LIC showed an initial capacity of 871 mAh/g stabilizing to 702 mAh/g after 100 cycles. These results support the theory that doped LICs enhance the cycling stability and rate capability of S—Cu-bpy-CFM cathodes by improving the sulfur utilization and anchoring polysulfides from entering the electrolyte.

Electronic conductor (EC) and lithium ion conductor (LIC) coated complex framework materials (CFMs) were constructed and tested. Novel doped lithium ion conductors (LICs) and ECs were chemically coated onto porous CFMs to improve their electronic conductivity (˜10⁻³S/cm) along with room-temperature lithium ion conductivity (˜10⁻⁴ S/cm). High sulfur loading (˜4.5-7 mg/cm²) cathodes with ˜64 wt % sulfur content were prepared from sulfur infiltrated EC-CFM and LIC-CFM. These cathodes were cycled against lithium metal using 1.8 M LiTFSI and 0.2 M LiNO₃ solution under lean electrolyte conditions (˜4 μl/mgS). The EC-CFM-S cathodes exhibited a stable specific capacity of 678 mAh/g and areal capacity of 3.8 mAh/cm² after 70 cycles when cycled at C/10 rate. The LIC-CFM-S cathodes on the other hand, exhibited a stable specific capacity of 662 mAh/g and areal capacity of 4.04 mAh/cm² after 70 cycles when cycled at C/10 rate.

A DFT based study was conducted to identify functional catalysts (FCs) for rapid conversion of polysulfides to Li₂S and to Li+S. The computation was performed for both reactions (1) and (2) at six different metal oxide surfaces. The decomposition energies ΔG of the various polysulfides are different for the different oxides used.

The aim of the foregoing experiments was to improve the cycling characteristics and reduce the polysulfide dissolution in Li—S batteries by using solid state lithium ion conductors (LICs) using DFT calculations. Undoped LIC coated S—Cu-bpy-CFM cathodes displayed an initial capacity of 873 mAh/g and a stable capacity of 583 mAh/g after 100 cycles. The doped LIC coated S—Cu-bpy-CFM cathodes on the other hand, showed much better cycling and rate capability due to higher Li-ion conductivity of doped LICs. Electrodes with doped LIC showed an initial capacity of 871 mAh/g stabilizing to 702 mAh/g after 100 cycles. In addition, sulfur architectures were developed by infiltrating sulfur into chemically coupled conducting complex framework materials (CFMs). Various complex framework materials systems (EC-CFM-S and LIC-CFM-S) were derived and evaluated as cathodes in lithium sulfur batteries. The EC-CFM-S showed a stable discharge capacity of 678 mAh/g after 70 cycles at C/10 rate, and LIC-CFM-S exhibited a high discharge capacity of 662 mAh/g after 70 cycles at C/10 rate.

### Example 2

Single layer Li—S pouch cells were fabricated and tested with an optimized S electrode of thickness 150 μm (calculated porosity ˜66%) with S loading 6.26 mg/cm² under lean electrolyte (4 μl/mg) conditions. Initial discharge specific capacity of ≈900 mAh/g was observed at C/20 rate stabilizing to ≈650 mAh/g capacity at 0.1 C rate after 5 cycles. The energy density of the pouch cell was ≈200 Wh/kg at 0.1 C rate (neglecting mass of pouch case and tabs). Other single layer pouch cells fabricated with various mass loading of S also displayed similar behavior.

Additionally, bi-functional catalysts promoting polysulfide (PS) conversion and decomposition suppressing the adverse polysulfide shuttling plaguing Li—S battery were added to the CFM to maximize S utilization. The CFM containing the bi-functional catalyst derived by a simple solid state scalable approach creating high surface area/pore volume likely provided high activity for PS trapping, conversion and decomposition. The 2032 coin cells were cycled with optimized S electrode of 107 μm thickness, porosity 63% and S loading 3.71 mg/cm². Initial capacity ≈700 mAh/g was observed, stabilizing at ˜730 mAh/g at C/20 rate after 2 cycles.

Example 3

Directly Doped Sulfur Architectures (DDSA) with sulfur loadings of ˜8-18 mg/cm² were created using simple electrodeposition technique. The DDSA electrodes were then coated with a Polysulfide Trapping Agent (PTA) to chemically prevent the dissolution of polysulfides. These free-standing cathodes were studied chemically and electrochemically to understand the mechanism of polysulfide dissolution in these structures. These PTA coated DDSA showed a high initial capacity of 1170±18 mAh/g and stable capacity of 897±27 mAh/cm² for over 100 cycles.

### EXPERIMENTAL

The synthesis of DDSA was accomplished by electrochemically depositing sulfur onto a conducting carbon nano fiber (CNF) matt. The CNF matt was prepared by electrospinning 1 M solution of polyacrylonitrile (PAN) into a nanofiber (˜200nm) matt at a high voltage of 25 kV and flow rate of 1 ml/h using an in-house-built electrospinning setup. The electro spun PAN matt was subsequently carbonized at 700° C. for 4 h in (ultra-high purity (UHP)-argon atmosphere (Matheson; 99.99%, flow rate of 100 cm³/min) to form the CNF matt. Sulfur was electrodeposited onto the CNF matt under aqueous electrolyte-conditions using a two-electrode setup. The electrolyte consisted of 4.8 g of sulfuric acid (98%, Sigma Aldrich), 0.3 g of KOH (99.9%, Sigma Aldrich), 0.5 M thiourea (99.9%, Sigma Aldrich) dissolved in 100 ml of deionized water. The CNF matt was used as the working electrode and a Pt foil was used as the counter electrode and by applying a constant voltage of 5V between the electrodes for 24 hours using a current limiting AC to DC transformer (25 A) from McMaster-Carr. During the electrodeposition process, the sulfate (SO₄²⁻) and hydroxy (OH⁻) ions were intercalated into the CNF, while the thiourea molecules infiltrated into the CNF and were converted into elemental sulfur particles. The DDSA electrodes had an average sulfur loading of ˜8-18 mg/cm². The DDSA on CNF matt was then electrochemically coated with gold (Au) which was selected as the polysulfide trapping agent (PTA). The PTA was electrodeposited onto the DDSA using gold chloride (200 mg/dL deionized water) (Sigma Aldrich) solution by applying a potential of 5V between Pt foil working electrode and DDSA counter electrode.

The X-ray diffraction patterns of the DDSA-PTA were collected using the Philips XPERT PRO system employing Cu—K_{α}(λ=0.15406 nm) between 2θ(10-40°) at 40 mA and 45 kV respectively. The microstructure and elemental composition of the DDSA-PTA was analyzed using JEOL JSM 6610 LV low-vac Scanning Electron Microscope (SEM) equipped with an Energy Dispersion Spectrometer (EDS). The surface chemistry of the DDSA-PTA was probed by X-ray photoelectron spectroscopy (XPS) using an ESCALAB250Xi system (Thermo Scientific) equipped with a mono-chromated Al—K_{α} X-ray source. Uniform charge neutralization was provided by beams of low-energy (≤10 eV) Ar⁺ ions and low-energy electrons guided by magnetic lens. The UV-VIS spectroscopic measurements were performed in UV-VIS Evol 600 using the organic electrolyte as the reference.

The electrochemical performance of the DDSA-PTA was evaluated in 2032 coin-cell. The coin cells for the electrochemical cycling were assembled inside an Argon-filled glovebox using the DDSA-PTA electrode as the cathode, lithium foil as anode and 1.8 M lithium trifluoro methane sulfonamide (LiTFSI) and 0.4 M LiNO₃ dissolved in dioxolane/dimethoxyethane (1:1 vol %) as electrolyte. The DOE's guidelines for lean electrolyte testing conditions, electrolyte to sulfur (E/S) ratio of 4 μl/mg-S was employed. The coin cells were tested in an Arbin BT200 battery cycler between 1.6-2.6 V (w.r.t. Li⁺/Li) at 0.1 C current rate. Electrochemical Impedance Spectroscopy (EIS) analysis were performed using a Gamry 600 potentiostat by varying the frequency between 100 kHz and 10 mHz at an amplitude of 10 mV w.r.t the open circuit potential of ˜2.2-2.4V. The obtained EIS data were then fitted using the ZView software (Scribner and Associates).

### Results and Discussion

The XRD analysis of the DDSA-PTA electrode showed peaks corresponding to crystalline sulfur confirming crystalline deposits of sulfur on the CNF matt. The microstructure of the CNF samples, DDSA samples before and after PTA electrodeposition were characterized by scanning electron microscopy (SEM). A SEM image of the CNF matt showed that the CNF fibers were smooth and of uniform thickness (1-2 μm). The empty regions between the CNF fibers provided room for accommodating sulfur via sulfur electrodeposition. The STEM image of the CNF matt after sulfur electrodeposition (DDSA-PTA) showed that the sulfur particles were of uniform size with an average diameter of 5-7 μm and the CNF matt was uniformly coated with the sulfur particles. The use of electrodeposition aided in preparing uniform sulfur deposits on the CNF matt. The sulfur, carbon and gold mappings of the DDSA-PTA showed that they match well with the STEM image, indicating that sulfur, carbon and gold were distributed homogeneously throughout the CNF-S composites. The elemental composition analysis showed the presence of ˜30 wt. % sulfur and ˜2 wt. % gold in the CNF matt comprising ˜62 wt. % carbon.

The electrochemical cycling plot of two DDSA-PTA samples from two batches synthesized under identical deposition conditions showed the cycling performance and rate-capability of the DDSA electrodes cycled at 0.1 C rate. The discharge capacity was calculated based on the weight of sulfur in the electrode measured from EDS. The DDSA-PTA electrodes exhibited a relatively stable discharge capacity during electrochemical charge-discharge cycling. The first and 100^{th} cycle discharge capacity of the DDSA-PTA (sample 1) is 1152 mAh/g and 925 mAh/g, respectively corresponding to an areal capacity of ˜11.29 mAh/cm². On the other hand, the first and 100^{th} cycle discharge capacity of the DDSA-PTA (sample 2) is 1188 mAh/g and 870 mAh/g, respectively giving an area capacity of ˜10.71 mAh/cm². Correspondingly the DDSA-PTA (sample 1) and DDSA-PTA (sample 2) electrodes exhibit very low fade rate of 0.20%/cycle and 0.26%/cycle, respectively while additionally exhibiting very high coulombic efficiency of ˜99.6%. The observation of slight fade in capacity is due to the formation of insulating Li₂S that is not completely oxidized upon charging and not due to polysulfide dissolution. It is deduced that the sulfur electrodeposited onto CNF mattes by the electrochemical method is responsible for the stable electrochemical cycling performance due to its physical and chemical interactions with polysulfides. In addition, the sulfur electrodeposition at the solid/liquid (CNF/aqueous thiourea solution) interface can ensure intimate contact of sulfur particles with the CNF mattes, effectively confining lithium polysulfides from dissolving into the organic liquid electrolyte. The rate capability of the DDSA-PTA (sample 3) electrode at different current densities from 0.1 C to 1 C rate was determined. A reversible capacity of ˜825 mAh/g was obtained at a current density of 0.2 C rate, owing to the good electrical conductivity of the CNF (1.81±0.17×10⁻⁵ S/cm) and contact with the uniformly dispersed S. The value of the discharge capacity was ˜589 and 492 mAh/g for 0.5 C and 1 C rate, respectively, and the discharge capacity returned to ˜918 mAh/g at 0.1 C rate, the electrode almost recovering its original capacity. This value to the best of our knowledge for discharge capacity at high sulfur loading is comparable to the best performance of sulfur cathode materials prepared by solution-based deposition technique and other methods.

X-ray photoelectron spectroscopy (XPS) was used to characterize the chemical state of sulfur in the DDSA-PTA separators and electrodes post cycling. The XPS spectra obtained from the DDSA-PTA separators and electrodes were compared with those obtained from corresponding separators and electrodes cycled with commercial sulfur cathode. The S2p XPS spectra was obtained for the DDSA-PTA (sample 1 and sample 2) separators collected after 100 cycles. The commercial sulfur separator after 100 cycles exhibited S2p peaks at 168.53 eV²², 167.14 eV^{1, 23} and 163.50 eV²⁴ corresponding to CF₃SO₃⁻ groups from the LiTFSI salt, lower and higher order polysulfides, respectively. However, the DDSA-PTA separators after cycling showed significant reduction in peak intensities at 167.14 eV and 163.50 eV confirming that there is almost negligible polysulfide dissolution in the DDSA-PTA system. Similarly, the commercial sulfur electrodes (sample 1 and sample 2) after cycling exhibited S2p peaks at 168.53 eV, 167.14 eV and 163.50 eV corresponding to CF₃SO₃⁻ groups from the LiTFSI salt, lower and higher order polysulfides, respectively. However, the DDSA-PTA electrodes after cycling showed significant reduction in peak intensities at 163.50 eV indicating the absence of higher order polysulfides on the DDSA-PTA cathode, which could be attributed to the polysulfide reduction property of Au. XPS results on the separators collected after 100 cycles of other DDSA-PTA electrodes were compared to the commercial sulfur cycled separator after 100 cycles. The UV-VIS spectroscopic analysis conducted on the DOL-DME solvent containing polysulfides added to the CNF matt, the DDSA and DDSA-PTA samples correspondingly also revealed the absence of higher order polysulfides in the polysulfide solution immersed in DDSA-PTA electrode.

The DDSA-PTA electrodes were further studied using electrochemical impedance spectroscopy (EIS) analysis before and after cycling. The Nyquist plots and the equivalent circuit used to fit the data showed that the experimental data fits well with the fitted data using the equivalent circuit. The Nyquist plots showed two semicircles, corresponding to the resistance of passivation film (interface resistance-Rᵢ) of the discharge product in the high-frequency region and the charge transfer resistance R_{ct} in the medium-frequency area. The R_{ct} decreased considerably after cycling due to complete wetting of the electrode by the electrolyte and the rearrangement of the migrated active materials to the electrochemically favorable position.

The interfacial resistance Rᵢ of the pristine as well as the cells after 1^{st} and 100^{th} cycle remained almost constant at ˜20 Ω, before and after the first cycle while the charge transfer resistance (R_{ct}) undergoes significant change with lithiation (after first cycle). This reduction in R_{ct} is likely due to the immobilization of polysulfides by the Au nanoparticles, thereby restricting the formation of the solid electrolyte interface (SEI) on the anode arising from the deposition of the low order polysulfides. All these electrochemical characterizations further suggest that the modest decoration of the cathode by the electrodeposition of Au nanoparticles has a profound influence on the improvement of the electrochemical performance of Li—S batteries.

### Summary

A simple electrodeposition technique was implemented to prepare PTA coated DDSA electrodes that were used as free-standing cathodes in Li—S batteries. The PTA-DDSA cathodes exhibited significantly reduced polysulfide dissolution as was evident from an XPS analysis, in addition to displaying excellent cycling stability. The DDSA-PTA electrode 1 exhibited an initial capacity of 1188 mAh/g (14.62 mAh/cm² areal capacity) and a stable capacity of 870 mAh/g (10.71 mAh/cm² areal capacity) after 100 cycles at 0.1 C rate. The DDSA-PTA electrode 2 showed an initial capacity of 1152 mAh/g (14.06 mAh/cm² areal capacity) and a stable capacity of 925 mAh/g (11.29 mAh/cm² areal capacity) after 100 cycles at 0.1 C rate. The PTA-DDSA electrodes exhibited very low fade rate of 0.23±0.03%/cycle and significantly reduced polysulfides when examined by XPS and UV-VIS spectroscopy. The EIS impedance analysis of the DDSA-PTA before and after cycling also suggests polysulfide immobilization by Au nanoparticles. The development of PTA-DDSA electrodes enables the use of high energy density battery systems consisting of sulfur cathodes with superior capacity retention and stability. This approach serves to expedite developments in high energy lithium-sulfur battery systems and help achieve the DOE's target of 500 Wh/kg.

### Example 4

### Synthesis of Lithium Ion Conductor on Carbon Framework (LIC-CFM-S) LiOPAN Coated CFM-S

Step 1: Complex Framework Material (CFM): (5.0 g) of super P was dispersed in a mixed solution of deionized water (25 ml) and dimethyl sulfoxide (DMSO) (25 ml) under ultrasonication (BRANSON, 5800, USA) for 10 min. Acrylonitrile monomer (10 ml) and azobisisobutyronitrile (AIBN, 100 mg) were then added. The mixed solution was stirred under a N₂ atmosphere for 4 h at 65°C to initiate the polymerization reaction. The resulting solid was collected by filtration and washed with ethanol after polymerization. The product was vacuum dried at 60° C. for 24 h to yield polyacrylnitrile (PAN) coated on carbon frame work (PAN/CFM). Any nitrogen containing carbon backbone based hydrocarbon polymer can also be selected.

Step 2: Sulfur Infiltration into the PAN/CFMs: The PAN/CFMs were dried under vacuum conditions at 60° C. for 24 h to remove any residual solvent and water of crystallization from the synthesis process. The synthesized PAN/CFMs were then infiltrated with sulfur under vacuum, using the following procedure, PAN/CFM and S (mass ratio 90:10) and 10 wt. % lithium salt such as lithium nitrate were ground together, then sealed and heated under argon at a rate of 5° C./min up to 240° C. The mixture was maintained at 240° C. for 12 h to obtain LIC-CFM/S, also termed as LiOPAN coated CFM-S.

The crystal structure of the PAN/CFM and PAN/CFM-S before and after sulfur infiltration was analyzed using the XRD spectroscopy in a Philips XPERT PRO system that uses Cu K.α(λ=0.15406 nm) radiation. The samples were scanned in the 2θ range of 10-90° under a constant current and voltage of 40 mA and 45 kV, respectively. The SEM images of the CFMs were obtained using a Philips XL30 machine at 10 kV, An attenuated total reflectance Fourier transform IR spectroscope (ATR-FTIR, Nicolet 6700 Spectrophotometer, Thermo Electron. Corporation), which uses a diamond ATR smart orbit, was used to obtain the FT-IR spectra of the samples. The FTIR spectra are collected at a resolution of 1 cm⁻¹, averaging 32 scans between the frequency of 400 and 4000 cm⁻¹. The X-ray photoelectron spectroscopy (XPS) analyses of the PAN/CFMs and PAN/CFM-S were performed using the ESCALAB 250 Xi system (Thermo Scientific), This XPS system consists of the monochromated Al Kα X-ray source and low-energy. (≤10 eV) argon ions and low-energy electron beams that provide the charge neutralization. The XPS measurements were carried out at room temperature, under an ultra-high vacuum (UHV) Chamber (<5×10⁻¹⁰ mBar) employing a spot size of 200×200 μm². The surface area and pore characteristics of all the CFM samples were analyzed using a Micromeritics ASAP 2020 Physisorption analyzer, using the BET isotherm generated.

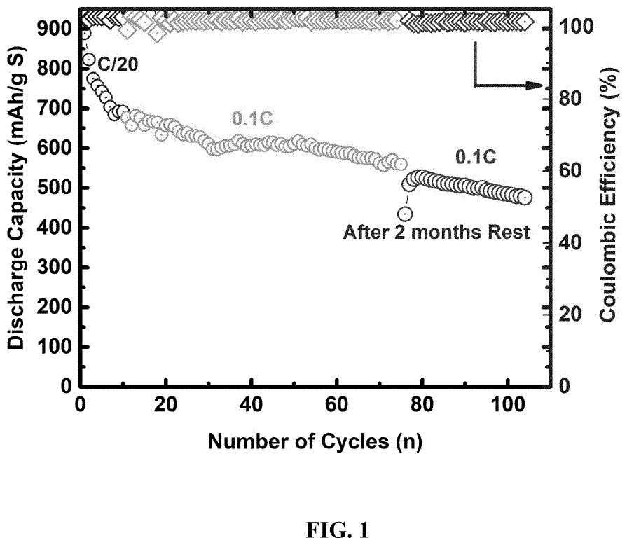

The LIC-CFM-S or LiOPAN coated CFM-S were cycled between 1.8 and 2.8 V (with respect to Li⁺/Li) at a current rate of 0.1 C in a 2032-coin cell and pouch cells using the Arbin BT200 battery testing station to evaluate their electrochemical performance. The cathodes for electrochemical evaluation were prepared by manually coating a dispersion of 70 wt. % LIC-CFM-S, 20 wt. % acetylene black, and 10 wt. % PVDF dispersed in N-methyl 2-pyrrolidone (NMP) on an aluminum foil, followed by vacuum drying for 12 h at 60° C. All the cathodes that were tested had a uniform sulfur loading of 4.0-6.0 mg/cm². Accordingly, 2032-coin cells were assembled with the LIC-CFM-S coated cathodes as the working electrode, a lithium foil as the counter electrode, and Celgard 2400 polypropylene (PP) as the separator in an Innovative, Inc. glove box (UHP Argon, <0.1 ppm O₂, H₂O). 1.8 M LITFSI (lithium bis (trifluoromethanesulfonyl)imide) and 0.4 M LiNO₃ dissolved in 50:50 vol % 1,3 dioxolane and 1,2 dimethoxyethane were used as the electrolytes. The lithium ion conductor (LIC-CFM-S) coordination of inter layer structure and pore volume of LIC-CFM-S provided high activity for catalytic conversion of Li-polysulfides (LiPS) and also sufficient entrapment of LiPS. FIG. 1 shows effectively the suppression of the shuttle effect, as a result, even under a C/20 rate under lean electrolyte condition of electrolyte (E) to sulfur (S) ratio of 4 μl/mg in a Li—S battery, the LIC-CFMS composite electrode still delivered a high initial capacity of 910.9 mAh/g that stabilizes to ˜600 mAh/mg.

### Example 5

### Functional Catalyst Preparation

Step 1: Two solutions were prepared. The first solution contained 60 mL of titanium butoxide dissolved in 250 mL methanol. The second solution contained 64 g of thiourea dissolved in 250 mL methanol. Solutions 1 and 2 were mixed together with magnetic stirrer at room temperature and after evaporation of methanol white powder was obtained. The white powder (S—TiO₂) was then calcinated at 400° C. (S—TiO_{2/}CFM) for 4 to 6 h (heating rate 5° C./min) to obtain sulfur containing titanium oxide.

Step 2: Sulfur Infiltration into the Sulphur doped into titanium oxide (S—Ti₂O/CFM: The sulfur doped titanium oxide carbon frame work (S—TiO₂-CFM) was dried under vacuum conditions at 60° C. for 12 h to remove residual solvent and the water of crystallization from the synthesis process. The synthesized S—TiO₂/CFMs were infiltrated with sulfur under vacuum using following the procedure. Precisely, S—TiO₂CFM and S (mass ratio 90:10) were ground together, then sealed and heated under argon at a heating rate of 5° C. min⁻¹ up to 240° C. The mixture was maintained at 240° C. for 12 h to obtain S—TiO₂CFM-S.

### Chemical and Electrochemical Characterization

The crystal structure of the S—TiO₂-CFM and S—TiO₂CFM-S before and after sulfur infiltration was analyzed using the XRD spectroscopy in a Philips XPERT PRO system that uses Cu Kα(λ=0.15406 nm) radiation. The samples were scanned in the 20 range of 10-90° under a constant current and voltage of 40 mA and 45 kV, respectively. The SEM images of the S—TiO₂-CFMs were obtained using a Philips XL30 machine at 10 kV. An attenuated total reflectance Fourier transform IR spectroscope (ATR-FTIR, Nicolet 6700 Spectrophotometer, Thermo Electron Corporation), which uses a diamond ATR smart orbit, was used to obtain the FT-IR spectra of the samples. The FTIR spectra are collected at a resolution of 1 cm⁻¹, averaging 32 scans between the frequency of 400 and 4000 cm⁻¹. The XPS analyses of the S—TiO₂CFMs and S—TiO₂CFM-S were performed using the ESCALAB 250 Xi system (Thermo Scientific). This XPS system consists of the monochromated Al Kα X-ray source and low-energy (≤10 eV) argon ions and low-energy electron beams that provide the charge neutralization. The XPS measurements were carried out at room temperature, under an ultra-high vacuum (UHV) chamber (<5×10⁻¹⁰ mBar) employing a spot size of 200×200 μm². The surface area and pore characteristics of all the S—TiO₂-CFM samples were analyzed using a Micromeritics ASAP 2020 Physisorption analyzer, using the BET isotherm generated.

The S—TiO₂-CFM-S were cycled between 1.8 and 2.8 V (with respect to Li⁺/Li) at a current rate of 0.2 C in a 2032-coin cell and pouch cells using the Arbin BT200 battery testing station to evaluate their electrochemical performance. The cathodes for electrochemical evaluation were prepared by manually coating a dispersion of 70 wt. % S—TiO₂CFM-S, 20 wt. % acetylene black, and 10 wt. % PVDF dispersed in N-methyl 2-pyrrolidone (NMP) on an aluminum foil, followed by vacuum drying for 12 h at 60° C. All the cathodes that were tested had a uniform sulfur loading of 4.0-6.0 mg/cm². Accordingly, 2032-coin cells were assembled with the S—TiO₂CFM-S coated cathodes as the working electrode, a lithium foil as the counter electrode, and Celgard 2400 polypropylene (PP) as the separator in an Innovative, Inc. glove box (UHP Argon, <0.1 ppm O₂, H₂O). An electrolyte solution of 1.8 M LiTFSI (lithium bis (trifluoromethanesulfonyl)imide) and 0.4 m LiNO₃ dissolved in 50:50 vol % 1,3 dioxolane and 1,2 dimethoxyethane was used as the electrolyte. The functional catalyst (S—TiO₂CFM-S) coordination configuration and inter layer area/pore volume of S—TiO₂CFM-S provided high activity for catalytic conversion of LiPS to Li2S and sufficient entrapment of EPS. The results showed the ability of the system to effectively suppress the shuttle effect, as a result, even under a C/5 rate under lean electrolyte condition of electrolyte (E) to sulfur (S) ratio of 4 μl/mg in a Li—S battery, the S—TiO₂CFM-S composite electrode still delivered a high reversible capacity of 750.9 mAh/g.

### Example 6

Bifunctional catalyst cathode materials synthesis: (BCCM). Mixtures of PAN (Sigma-aldrich, 99.5%), boron nitride (RN) (Sigma-aldrich, 99.5%), titanium sulfide (TiS₂) (Sigma-aldrich) and iron (Fe, 98%, Alfa Aesar) corresponding to the stoichiometric composition with urea (˜10%) as a porogen were subjected to high energy mechanical milling (HEMM) in a high energy shaker mill for 1 h in a stainless steel (SS) vial using 20 SS balls of 2 mm diameter with a ball to powder weight ratio 10:1. The milled powder was then heat treated at 700° C. for 6 h (Ramp rate of 5° C./min) in argon atmosphere.

The BCCMs were dried under vacuum conditions at 60° C. for 12 h to remove residual solvent and the water of crystallization from the synthesis process. The synthesized BCCMs s were infiltrated with sulfur under vacuum using the following the procedure. The BCCM and S (mass ratio 90:10) were ground together, then sealed and heated under argon at a rate of 10° C./min up to 300° C. The mixture was maintained at 300° C. for 12 h to obtain BCCM-S.

### Chemical and Electrochemical Characterization

The crystal structure of the BCCM and BCCM-S before and after sulfur infiltration was analyzed using the XRD spectroscopy in a Philips)(PERT PRO system that uses Cu Kα(λ=0.15406 nm) radiation. The samples were scanned in the 20 range of 10-90° under a constant current and voltage of 40 mA and 45 kV, respectively. The SEM images of the CFMs were obtained using a Philips XL30 machine at 10 kV. An attenuated total reflectance Fourier transform IR spectroscope (ATR-FTIR, Nicolet 6700 Spectrophotometer, Thermo Electron Corporation), which uses a diamond ATR smart orbit, was used to obtain the FT-IR spectra of the samples. The FTIR spectra are collected at a resolution of 1 cm⁻¹, averaging 32 scans between the frequency of 400 and 4000 cm⁻¹. The XPS analyses of the BCCMs and BCCM-S were performed using the ESCALAB 250 Xi system (Thermo Scientific). This XPS system consists of the monochromated Al Kα X-ray source and low-energy (≤10 eV) argon ions and low-energy electron beams that provide the charge neutralization. The XPS measurements were carried out at room temperature, under an ultra-high vacuum (UHV) chamber (<5×10⁻¹⁰ mBar) employing a spot size of 200×200 μm². The surface area and pore characteristics of all the BCCM-S samples were analyzed using a Micromeritics ASAP 2020 Physisorption analyzer, using the BET isotherm generated.

The BCCM-S were cycled between 1.8 and 2.8 V (with respect to Li⁺/Li) at a current rate of 0.2 C rate in a 2032-coin cell and pouch cells using the Arbin BT200 battery testing station to evaluate their electrochemical performance. The cathodes for electrochemical evaluation were prepared by manually coating a dispersion of 70 wt. % BCCMS, 20 wt. % acetylene black, and 10 wt. % PVDF dispersed in N-methyl -2 pyrrolidone (NMP) on an aluminum foil, followed by vacuum drying for 12 h at 60° C. All the cathodes that were tested had a uniform sulfur loading of 4.0-6.0 mg/cm². Accordingly, 2032-coin cells were assembled with the BCCM-S coated cathodes as the working electrode, a lithium foil as the counter electrode, and Celgard 2400 polypropylene (PP) as the separator in an Innovative, Inc. glove box (UHP Argon, <0.1 ppm O₂, H₂O). A 1.8 M LITFSI (lithium bis (trifluoromethanesulfonyl)imide) and 0.4 m LiNO₃ dissolved in 50:50 vol % 1,3 dioxolane and 1,2 dimethoxyethane were used as the electrolytes. The bifunctional catalysts of (TiS₂—Fe) present in the complexed framework material of C with appropriate coordination configuration and high surface area/pore volume of TiS₂—Fe—C provide high activity for catalytic conversion of LiPS to Li₂S and sufficient entrapment of LiPS. The results showed the ability of the system to effectively suppress the shuttle effect. As a result, even under a C/20 rate under lean electrolyte conditions of electrolyte (E) to sulfur (S) ratio of 4 μl/mg in a Li—S battery, the S—TiS₂—Fe—C (BCCMS) composite electrode still delivered a high reversible capacity of 710.9 mAh/g.

### Example 7

### Synthesis of Lithium Ion Conductor (LIC) Coated on Bifunctional Catalyst Cathode Materials (LIC-BCCM/S)

Mixtures of polyacrylonitrile (PAN) (Sigma-aldrich, 99.5%), boron nitride (BN) (Sigma-aldrich, 99.5%), titanium di sulfide (TiS₂) (Sigma-Aldrich) and iron (Fe, 98%, Alfa. Aesar) corresponding to the stoichiometric composition were subjected to high energy mechanical milling (HEMM) in a high energy shaker mill for 1 h in a stainless steel (SS) vial. using 20 SS balls of 2 mm diameter with a ball to powder weight ratio 10:1. The milled powder was then heat treated in air at 700° C. for 6 h (Ramp rate=5° C./min) in argon atmosphere. Generation of the LIC coated BCCMS was generated following the two steps below.

Step 1: Bifunctional catalyst cathode materials (BCCM, 5.0 g) was dispersed in a mixed solution of deionized water (25 ml) and dimethyl sulfoxide (DMSO) (25 ml) under ultrasonication (BRANSON, 5800, USA) for 10 min. Acrylonitrile monomer (10 ml) and AIBN (100 mg) were then added. The mixed solution was stirred under a N₂ atmosphere for 4 h at 65° C. to conduct the polymerization. The resulting solid was collected by filtration and washed with ethanol after polymerization. The product was vacuum dried at 60° C. for 24 h to yield PAN/BCCM.

Step 2: Sulfur Infiltration into the PAN/BCCMs: The PAN/BCCMs were dried under vacuum conditions at 60° C. for 12 h to remove residual solvent and the water of crystallization from the synthesis process. The synthesized PAN/ BCCMs were infiltrated with sulfur under vacuum according to the following procedure. PAN/BCCM and S (mass ratio 90:10) and 10 wt. % lithium salt of LiNO₃ were ground together, then sealed and heated under argon at a rate of 5° C./min up to 240° C. The mixture was maintained at 240° C. for 12 h to obtain lithium ion conductor coated on bifunctional catalyst cathode materials (LIC-BCCM/S).

### Chemical and Electrochemical Characterization

The crystal structure of the BCCM and LIC-BCCMS before and after sulfur infiltration was analyzed using the XRD spectroscopy in a Philips XPERT PRO system that uses Cu Kα(λ=0.15406 nm) radiation. The samples were scanned in the 20 range of 10-90° under a constant current and voltage of 40 mA and 45 kV, respectively. The SEM images of the CFMs were obtained using a Philips XL30 machine at 10 kV. An attenuated total reflectance Fourier transform IR spectroscope (ATR-FTIR, Nicolet 6700 Spectrophotometer, Thermo Electron Corporation), which uses a diamond ATR smart orbit, was used to obtain the FT-IR spectra of the samples. The FTIR spectra are collected at a resolution of 1 cm⁻¹, averaging 32 scans between the frequency of 400 and 4000 cm⁻¹. The XPS analyses of the BCCMs and LIC-BCCMS were performed using the ESCALAB 250 Xi system (Thermo Scientific). This XPS system consists of the monochromated Al Kα X-ray source and low-energy (≤10 eV) argon ions and low-energy electron beams that provide the charge neutralization. The XPS measurements were carried out at room temperature, under an ultra-high vacuum (UHV) chamber (<5×10⁻¹⁰ mBar) employing a spot size of 200×200 μm². The surface area and pore characteristics of all the BCCM samples were analyzed using a Micromeritics ASAP 2020 Physisorption analyzer, using the BET isotherm generated.

The LiC-BCCM/S were cycled between 1.8 and 2.8 V (with respect to Li⁺/Li) at a current rate of 0.2 C in a 2032-coin cell and pouch cells using the Arbin BT200 battery testing station to evaluate their electrochemical performance. The cathodes for electrochemical evaluation were prepared by manually coating a dispersion of 70 wt. % LiC-BCCMS, 20 wt. % acetylene black, and 10 wt. % PVDF dispersed in N-methyl pyrrolidone (NMP) on an aluminum foil, followed by vacuum drying for 12 h at 60 C. All the cathodes that were tested had a uniform sulfur loading of 4.0-6.0 mg/cm². Accordingly, 2032-coin cells were assembled with the LiC-BCCMS coated cathodes as the working electrode, a lithium foil as the counter electrode, and Celgard 2400 polypropylene (PP) as the separator in an Innovative, Inc. glove box (UHP Argon, <0.1 ppm O₂, H₂O). A 1.8 m LITFSI (lithium bis(trifluoromethanesulfonyl) imide) and 0.4 m LiNO₃ dissolved in 50:50 vol % 1,3 dioxolane and 1,2 dimethoxyethane were used as the electrolytes. The bifunctional catalyst coated with LIC (LIC-BCCMS) coordination configuration and high surface area/pore volume of of LIC-Ti₂S—Fe—C provided high activity for catalytic conversion of LiPS to Li₂S and sufficient entrapment of LiPS. As a result, even under a C/20 rate under lean electrolyte condition of electrolyte (E) to sulfur (S) ratio of 4 μl/mg in a Li—S battery in a Li—S battery, the LIC-S—TiS₂—Fe—C composite electrode still delivered a high reversible capacity of 400-450 mAh/g.

### Example 8

### 3D Printing CFMS-Graphene Architecture: Sulfur Infiltration into the S-CFM

The complex framework material (CFM) was dried under vacuum conditions at 60° C. for 12 h to remove residual solvent and the water of crystallization from the synthesis process. The synthesized CFMs were infiltrated with sulfur under vacuum, in the following manner. The complex framework material (CFM) and S (mass ratio 30:70) were ground together, then sealed and heated under argon at a rate of 5° C./min up to 240° C. The mixture was maintained at 240° C. for 12 h to obtain CFM-S.

3D-printed. S-CFM cathode was fabricated using a custom-made 3D printer of Cellink equipped with a 3-axis micropositioning stage printer. The printing process is as follows: S-CFM composite, polyvinylidene fluoride (PVDF)-hexafluoropropylene (HFP), graphene with a weight ratio of 70:20:10 were first mixed with 1-methyl-2-pyrrolidone (NMP) to form an ink. The as-prepared ink was then loaded into a 10 mL syringe and extruded through a 150 μm diameter nozzle. The 3D-printed S-CFM cathodes were printed onto a disk of diameter of 10 mm at a print motion speed of 6 mm/s. The printed electrode used two different treatments for comparison: 1) Firstly, printed electrodes were immediately immersed in a water (100 mL) coagulation bath for 5 min. It is noted that it formed phase inversion during this process. The binder network, electron paths and ion channels formed during phase inversion can significantly improve adhesive strength, facilitate electron/ion transport. Following this, freeze drying was conducted at −50° C. to maintain the structure formed during 3D printing and phase inversion. The obtained electrode named as 3DPFDE.

### Chemical and Electrochemical Characterization

The crystal structure of the complex framework materials (CFMS) and 3D printed freeze dried electrodes (3DPFDE) was analyzed using the XRD spectroscopy in a Philips XPERT PRO system that uses Cu Kα(λ=0.15406 nm) radiation. The samples were scanned in the 2θ range of 10-90° under a constant current and voltage of 40 mA and 45 kV, respectively. The SEM images of the 3DPFDE were obtained using a Philips XL30 machine at 10 kV. An attenuated total reflectance Fourier transform IR spectroscope (ATR-FTIR, Nicolet 6700 Spectrophotometer, Thermo Electron Corporation), which used a diamond ATR smart orbit, was used to obtain the FT-IR spectra of the samples. The FTIR spectra were collected at a resolution of 1 cm⁻¹, averaging 32 scans between the frequency of 400 and 4000 cm⁻¹. The XPS analyses of the SCFMs and 3DPFDE were performed using the ESCALAB 250 Xi system (Thermo Scientific). This XPS system consisted of the monochromated Al Kα X-ray source and low-energy (≤10 eV) argon ions and low-energy electron beams that provided the charge neutralization. The XPS measurements were carried out at room temperature, under an ultra-high vacuum (UHV) chamber (<5×10-10 mBar) employing a spot size of 200×200 μm². The surface area and pore characteristics of all the SCFM, 3DPFDE samples were analyzed using a Micromeritics ASAP 2020 Physisorption analyzer, using the BET isotherm generated.

The 3D Printed freeze dried electrodes(3DPFDE) were cycled between 1.8 and 2.8 V (with respect to Li⁺/Li) at a current rate of 0.2 C in a 2032-coin cell using the Arbin BT200 battery testing station to evaluate their electrochemical performance. The cathodes for electrochemical evaluation were prepared by 3DPrinting method a dispersion of 70 wt. % SCFMs, 20 wt. % graphene, and 10 wt. % PVDF dispersed in N-methyl-2 pyrrolidone (3DPink). All the cathodes that were tested had a uniform sulfur loading of 4.0-6.0 mg/cm². Accordingly, 2032-coin cells were assembled with the 3DPFDE printed cathodes as the working electrode, a lithium foil as the counter electrode, and Celgard 2400 polypropylene (PP) as the separator in an Innovative, Inc. glove box (IMP Argon, <0.1 ppm O₂, H₂O). An electrolyte solution containing 1.8 M LITFSI (lithium bis(trifluoromethanesulfonyl)imide) and 0.4 m LiNO₃ dissolved in 50:50 vol % 1,3 dioxolane and 1,2 dimethoxyethane was used as the electrolyte. The 3DP electrodes (3DPFDE) coordination inter connected materials and high surface area/pore volume of 3DPFDE provide high activity for conversion of the polysulfides, LiPS to Li₂S and sufficient entrapment of UPS. The results showed the ability of the system to effectively suppress the shuttle effect. As a result, even under a C/20 rate under lean electrolyte condition of electrolyte (E) to sulfur (S) ratio of 4 μl/mg in a Li—S battery, the 3D Printed architecture electrode still delivers a high reversible capacity of 810 mAh/g.

### Example 9

### Synthesis of Electronic conductor Coated on CFM (EC-CFM)

Complex framework material (CFM, 5.0 g) was dispersed in a mixed solution of deionized water (25 ml) and dimethyl sulfoxide (DMSO) (25 ml) under ultrasonication (BRANSON, 5800, USA) for 10 min. Acrylonitrile monomer (10 ml) and azobisisobutyronitrile (AIBN, 100 mg) were then added. The mixed solution was stirred under a N₂ atmosphere for 4 h at 65° C. to conduct the polymerization. The resulting solid was collected by filtration and washed with ethanol after polymerization. The product was vacuum dried at 60° C. for 24 h to yield PAN/CFM. The composite material was then heat treated in argon at 700° C. for 6 h (Ramp rate=5° C./min). The synthesized EC-CFMs were infiltrated with sulfur under vacuum, following the procedure as follows. The EC-CFM and S (mass ratio 90:10) were ground together, then sealed and heated under argon at a rate of 5° C./min up to 240° C. The mixture was maintained at 240° C. for 12 h to obtain EC-CFM/S.

### Chemical and Electrochemical Characterization

The crystal structure of the EC-CFM and EC-CFM-S before and after sulfur infiltration was analyzed using the XRD spectroscopy in a Philips XPERT PRO system that uses Cu Kα(λ=0.15406 nm) radiation. The samples were scanned in the 20 range of 10-90° under a constant current and voltage of 40 mA and 45 kV, respectively. The SEM images of the EC-CFMs were Obtained using a Philips XL30 machine at 10 kV. An attenuated total reflectance Fourier transform IR spectroscope (ATR-FTIR, Nicolet 6700 Spectrophotometer, Thermo Electron Corporation), which uses a diamond ATR smart orbit, was used to obtain the FT-IR spectra of the samples. The FTIR spectra are collected at a resolution of 1 cm⁻¹, averaging 32 scans between the frequency of 400 and 4000 cm⁻¹. The XPS analyses of the EC-CFMs and EC-CFMS were performed using the ESCALAB 250 Xi system (Thermo Scientific). This XPS system consists of the monochromated Al Kα X-ray source and low-energy (≤10 eV) argon ions and low-energy electron beams that provide the charge neutralization. The XPS measurements were carried out at room temperature, under an ultra-high vacuum (UTIV) chamber (<5×10⁻¹⁰ mBar) employing a spot size of 200×200 μm². The surface area and pore characteristics of all the EC-CFM, EC-CFMS samples were analyzed using a Micromeritics ASAP 2020 Physisorption analyzer, using the BET isotherm generated.

The EC-CFMS were cycled between 1.8 and 2.8 V (with respect to Li⁺/Li) at a current rate of 0.2 C in a 2032-coin cell using the Arbin BT200 battery testing station to evaluate their electrochemical performance. The cathodes for electrochemical evaluation were prepared by manually coating a dispersion of 70 wt. % EC-CFMs, 20 wt. % Super P, and 10 wt. % PVDF dispersed in N-methyl pyrrolidone. All the cathodes that were tested had a uniform sulfur loading of 4.0-6.0 mg/cm². Accordingly, 2032-coin cells were assembled with the EC-CFMS coated cathodes as the working electrode, a lithium foil as the counter electrode, and Celgard 2400 polypropylene (PP) as the separator in an Innovative, Inc. glove box (UHP Argon, <0.1 ppm O₂, H₂O). A 1.8 M LITFSI (lithium bis(trifluoromethanesulfonylimide) and 0.4 m LiNO₃ dissolved in 50:50 vol % 1,3 dioxolane and 1,2 dimethoxyethane were used as the electrolytes. The electronic coated electrodes (EC-CFMS) coordination configuration and high surface area/pore volume of EC-CFMS provide high activity for conversion of the polysulfides, LiPS to Li₂S and sufficient entrapment of LiPS. The results showed effective suppression of the shuttle effect. As a result, even under a C/20 rate under lean electrolyte condition of electrolyte (E) to sulfur (S) ratio of 4 μl/mg in a Li—S battery in a Li—S battery, the electronic conductor coated on EC-CFMS composite electrode still delivers a high reversible capacity of 700 mAh/g.

### Example 10

### Synthetic Polymer Binder with Carbon Framework Materials (CFM-S)

The complex framework materials (CFMs) were dried under vacuum conditions at 60° C. for 12 h to remove residual solvent and the water of crystallization from the synthesis process. The synthesized CFMs were infiltrated with sulfur under vacuum, following the procedure. The CFM and S (mass ratio 10:90) were ground together, then sealed and heated under argon at a rate of 5 C/min up to 240° C. The mixture was maintained at 240° C. for 12 h to obtain CFM-S.

The synthetic polymer binder was prepared as follows. Chitosan (Sigma Aldrich 99%) was dissolved in 1% acetic acid in water. Poly-vinyl alcohol (PVA) (Sigma Aldrich 99%) was dissolved in water. An 80 wt. % Chitosan and 20 wt. % PVA were then mixed together and stirred for 24 h. This clear solution was used as the binder.

### Chemical and Electrochemical Characterization

The crystal structure of the CFM and CFM-S before and after sulfur infiltration was analyzed using the XRD spectroscopy in a Philips XPERT PRO system that uses Cu Kα(λ=0.15406 nm) radiation. The samples were scanned in the 20 range of 10-90° under a constant current and voltage of 40 mA and 45 kV, respectively. The SEM images of the CFMs were obtained using a Philips XL30 machine at 10 kV. An attenuated total reflectance Fourier transform IR spectroscope (ATR-FTIR, Nicolet 6700 Spectrophotometer, Thermo Electron Corporation), which uses a diamond. ATR smart orbit, was used to obtain the FT-IR spectra of the samples. The Fru spectra were collected at a resolution of 1 cm⁻¹, averaging 32 scans between the frequency of 400 and 4000 cm⁻¹. The XPS analyses of the CFMs and CFM-S were performed using the ESCALAB 250 Xi system (Thermo Scientific). This XPS system consisted of the monochromated Al Kα X-ray source and low-energy (≤10 eV) argon ions and low-energy electron beams that provided the charge neutralization. The XPS measurements were carried out at room temperature, under an ultra-high vacuum (UHV) chamber (<5×10⁻¹⁰ mBar) employing a spot size of 200×200 μm². The surface area and pore characteristics of all the CFM, CFM-S samples were analyzed using a Micromeritics ASAI 2020 Physisorption analyzer, using the BET isotherm generated.

The CFM-S were cycled between 1.8 and 2.8 V (with respect to Li⁺/Li) at a current rate of 0.2 C in a 2032-coin cell using the Arbin BT200 battery testing station to evaluate their electrochemical performance. The cathodes for electrochemical evaluation were prepared by manually coating a dispersion of 70 wt. % CFM-S, 20 wt. % Super P, and 10 wt. synthetic polymer binder solution dispersed in water. All the cathodes that were tested had a uniform sulfur loading of 4.0-6.0 mg/cm². Accordingly, 2032-coin cells were assembled with the CFM-S coated cathodes as the working electrode, a lithium foil as the counter electrode, and Celgard 2400 polypropylene (PP) as the separator in an Innovative, Inc. glove box (UHP Argon, <0.1 ppm O₂, H₂O). A 1.8 M LITFSI (lithium bis(trilluoromethanesulfonyl)imide) and 0.4 M LiNO₃ dissolved in 50:50 vol % 1,3 dioxolane and 1,2 dimethoxyethane were used as the electrolytes. The CFM-S electrodes with synthetic polymer binder and functional groups/pore volume of CFM-S provide high activity for conversion of the polysulfides, LiPS to Li2S with sufficient entrapment of LiPS. The results showed effective suppression of the shuttle effect. As a result, even under a C/20 rate under lean electrolyte condition in a Li—S battery, the CFM-S composite electrode still delivers a high reversible capacity of 800 mAh/g although the initial capacity is low indicating activation that is needed to ensure good wetting of the electrodes.

### Example 11

### Hybrid Active Aterials Synthesis: (HBAS)

Mixtures of complex framework materials (CFMs), sulfur and functional monomer (FM) of tri-thio cyanuric acid (Sigma Aldrich 99%), corresponding to the stoichiometric composition of 70:20:10 or 80:10:10 were used. Any N containing ring compound with at least three thiol groups can be used. The hybrid active materials were dried under vacuum conditions at 60° C. for 12 h to remove residual solvent and the water of crystallization from the synthesis process. Next, the hybrid active materials sulfur, CFM and FM (mass ratio 70:20:10) were ground together, then sealed and heated under argon at a rate of 5° C./min up to 240° C. The mixture was maintained at 240° C. for 12 h to obtain hybrid active materials. To this mixture LiNO₃ can also be added to create a lithium ion conducting framework or essentially LiOPAN coated HBAS as described in Example 4.

### Chemical and Electrochemical Characterization

The crystal structure of the sulfur, CFMs, FM and hybrid active materials before and after sulfur infiltration was analyzed using the XRD spectroscopy in a Philips XPERT PRO system that uses Cu Kα(λ=0.15406 nm) radiation. The samples were scanned in the 2θ range of 10-90° under a constant current and voltage of 40 mA and 45 kV, respectively. The SEM images of the hybrid active materials were obtained using a Philips XL30 machine at 10 kV. An attenuated total reflectance Fourier transform IR spectroscope (ATR-FTIR, Nicolet 6700 Spectrophotometer, Thermo Electron Corporation), which uses a diamond ATR smart orbit, was used to obtain the FT-IR spectra of the samples. The FTIR spectra were collected at a resolution of 1 cm⁻¹, averaging 32 scans between the frequency of 400 and 4000 cm⁻¹. The XPS analyses of the starting materials and hybrid active materials were performed using the ESCALAB 250 Xi system (Thermo Scientific). This XPS system consisted of the monochromated Al Kα X-ray source and low-energy (≤10 eV) argon ions and low-energy electron beams that provided the charge neutralization. The XPS measurements were carried out at room temperature, under an ultra-high vacuum (UHV) chamber (<5×10⁻¹⁰ mBar) employing a spot size of 200×200 μm². The surface area and pore characteristics of all the hybrid active materials were analyzed using a Micromeritics ASAP 2020 Physisorption analyzer, using the BET isotherm generated.

The hybrid active materials were cycled between 1.8 and 2.8 V (with respect to Li⁺/Li.) at a current rate of 0.2 C in a 2032-coin cell using the Arbin BT200 battery testing station to evaluate their electrochemical performance. The cathodes for electrochemical evaluation were prepared by manually coating a dispersion of 70 wt. % HBA, 20 wt. % acetylene black, and 10 wt % PVDF dispersed in N-methyl 2-pyrrolidone (NMP) on an aluminum foil, followed by vacuum drying for 12 h at 60° C. All the cathodes that were tested had a uniform sulfur loading of 4.0-6.0 mg/cm². Accordingly, 2032-coin cells were assembled with the hybrid active materials coated cathodes as the working electrode, a lithium foil as the counter electrode, and Celgard 2400 polypropylene (PP) as the separator in an Innovative, Inc. glove box (UHP Argon, <0.1 ppm O₂, H₂O). A 1.8 M LITFSI (lithium bis(trifluoromethanesulfonyl)imide) and 0.4 m LiNO₃ dissolved in 50:50 vol % 1,3 dioxolane and 1,2 dimethoxyethane were used as the electrolyte. The hybrid active materials coordination configuration and high surface area/pore volume of functional monomer provide high activity for conversion of poly sulfides, LiPS to Li₂S and sufficient entrapment of LIPS. The results showed the cycling response indicating effective suppression of the shuttle effect. As a result, even under a C/20 rate under lean electrolyte condition of electrolyte (E) to sulfur (S) ratio of 4 μl/mg in a Li—S battery, the hybrid active materials architecture electrode still delivered a high reversible capacity of 1300 mAh/g stabilizing to 1000 mAh/g.

### Example 12

### Inorganic Framework Materials 1—IFM-S

The IFM (Boron Nitride, Sigma Aldrich 99%) was dried under vacuum conditions at 60° C. for 12 h to remove residual solvent and the water of crystallization from the synthesis process. The IFMs were infiltrated with sulfur under vacuum using the following procedure. The IFM and S (mass ratio 10:90) were ground together, then sealed and heated under argon at a rate of 5° C./min up to 240° C. The mixture was maintained at 240° C. for 12 h to obtain IFM-S.

### Chemical and Electrochemical Characterization

The crystal structure of the IFM and IFM-S before and after sulfur infiltration was analyzed using the XRD spectroscopy in a Philips XPERT PRO system that uses Cu Kα(λ=0.15406 nm) radiation. The samples were scanned in the 20 range of 10-90° under a constant current and voltage of 40 mA and 45 kV, respectively. The SEM images of the IFMs were obtained using a Philips XL30 machine at 10 kV. An attenuated total reflectance Fourier transform IR spectroscope (ATR-FTIR, Nicolet 6700 Spectrophotometer, Thermo Electron Corporation), which uses a diamond ATR smart orbit, was used to obtain the FT-IR spectra of the samples. The FTIR spectra are collected at a resolution of 1 cm⁻¹, averaging 32 scans between the frequency of 400 and 4000 cm⁻¹. The XPS analyses of the IFMs and IFM-S were performed using the ESCALAB 250 Xi system (Thermo Scientific). This XPS system consists of the monochromated Al Kα X-ray source and low-energy (≤10 eV) argon ions and low-energy electron beams that provide the charge neutralization. The XPS measurements were carried out at room temperature, under an ultra-high vacuum (UHV) chamber (<5×10⁻¹⁰ mBar) employing a spot size of 200×200 μm². The surface area and pore characteristics of all the IFM, IFM-S samples were analyzed using a Micromeritics ASAP 2020 Physisorption analyzer, using the BET isotherm generated.

The IFM-S were cycled between 1.8 and 2.8 V (with respect to Li⁺/Li) at a current rate of 0.2 C in 2032 and 2025 coin cells using the Arbin BT200 battery testing station to evaluate their electrochemical performance. The cathodes for electrochemical evaluation were prepared by manually coating a dispersion of 70 wt. % IFM-S, 20 wt. % Super P, and 10 wt. % PVDF binder dispersed in N-methyl 2-pyrrolidone. All the cathodes that were tested had a uniform sulfur loading of 4.0-6.0 mg/cm². Accordingly, 2032 and 2025 coin cells were assembled with the IFM-S coated cathodes as the working electrode, a lithium foil as the counter electrode, and Celgard 2400 polypropylene (PP) as the separator in an innovative, Inc. glove box (UHP Argon, <0.1 ppm O₂, H₂O). 1.8 M LITFSI (lithium bis(trifluoromethanesulfonyl)imide) and 0.4 M LiNO₃ dissolved in 50:50 vol % 1,3 dioxolane and 1,2 dimethoxyethane were used as the electrolyte. The IFMS coated electrodes (IFM-S) coordination and high surface area/pore volume of IFMS provided high activity for conversion of LiPS to Li₂S with sufficient entrapment of LiPS. The results showed the cycling response indicating effective suppression of the shuttle effect. As a result, even under a C/20 rate under lean electrolyte condition of electrolyte (E) to sulfur (S) ratio of 4 μl/mg in a Li—S battery, the CFM-S composite electrode still delivered a stable reversible capacity of 500-600 mAh/g in both cell configurations.

### Example 13

### Inorganic Framework Materials2—ZSM-S

The IFMs (ZSM-5, ACS Material) were dried under vacuum conditions at 60° C. for 12 h to remove residual solvent and the water of crystallization from the synthesis process. The ZSMs were infiltrated with sulfur under vacuum, following the procedure as follows. The ZSM and S (mass ratio 10:90) were ground together, then sealed and heated under argon at a rate of 5° C./min up to 240° C. The mixture was maintained at 240° C. for 12 h to obtain ZSM-S.

### Chemical and Electrochemical Characterization

The crystal structure of the ZSM and ZSM-S before and after sulfur infiltration was analyzed using the XRD spectroscopy in a Philips XPERT PRO system that uses Cu Kα(λ=0.15406 nm) radiation. The samples were scanned in the 20 range of 10-90° under a constant current and voltage of 40 mA and 45 kV, respectively. The SEM images of the ZSMs were obtained using a Philips XL30 machine at 10 kV. An attenuated total reflectance Fourier transform IR spectroscope (ATR-FTIR, Nicolet 6700 Spectrophotometer, Thermo Electron Corporation), which uses a diamond ATR smart orbit, was used to obtain the FT-IR spectra of the samples. The FTER spectra are collected at a resolution of 1 cm⁻¹, averaging 32 scans between the frequency of 400 and 4000 cm⁻¹. The XPS analyses of the ZSMs and ZSM-S were performed using the ESCALAB 250 Xi system (Thermo Scientific). This XPS system consists of the monochromated Al Kα X-ray source and low-energy (≤10 eV) argon ions and low-energy electron beams that provide the charge neutralization. The XPS measurements were carried out at room temperature, under an ultra-high vacuum (UHV) chamber <5×10⁻¹⁰ mBar) employing a spot size of 200×200 μm². The surface area and pore characteristics of all the ZSM, ZSM-S samples were analyzed using a Micromeritics ASAP 2020 Physisorption analyzer, using the BET isotherm generated.

The ZSM-S were cycled between 1.8 and 2.8 V (with respect to Li⁺/Li) at a current rate of 0.2 C in a 2032-coin cell using the Arbin BT200 battery testing station to evaluate their electrochemical performance. The cathodes for electrochemical evaluation were prepared by manually coating a dispersion of 70 wt. % ZSM-S, 20 wt. % Super P, and 10 wt. % PVDF binder dispersed in N-methyl pyrrolidone. All the cathodes that were tested had a uniform sulfur loading of 4.0-6.0 mg/cm². Accordingly, 2032-coin cells were assembled with the ZSM-S coated cathodes as the working electrode, a lithium foil as the counter electrode, and Celgard 2400 polypropylene (PP) as the separator in an Innovative, Inc. glove box (UHP Argon, <0.1 ppm O₂, H₂O). Electrolyte of 1.8 M LITFSI (lithium bis(trifluoromethanesulfonyl)imide) and 0.4 M LiNO₃ dissolved in 50:50 vol % 1,3 dioxolane and 1,2 dimethoxyethane were used as the electrolytes. The ZSMS coated electrodes (ZSM-S) coordination with metals (Al and Si) and high surface area/pore volume of ZSMS provide high activity for conversion of LiPS to Li₂S with sufficient entrapment of LIPS. The results showed the cycling response indicating effective suppression of the shuttle effect. As a result, even under a C/20 rate under lean electrolyte conditions of electrolyte (E) to sulfur (S) ratio of 4 μl/mg in a Li—S battery, the CFM-S composite electrode still delivers a high reversible capacity of 600-700 mAh/g.

### Example 14

### PAN coating on Super P/YP-80F

The commercial Super P/YP-80F (1.0 g) was mixed in a solution of deionized water (125 ml), dimethyl sulfoxide (DMSO, 125 ml) and stirred under argon atmosphere at 80° C. for 30 min. This was followed by the addition of 375.0 mg of 2,2′-Azobisisobutyronitrile (AIBN) to the mixture, with the temperature of the mixture raised to 85° C. and the entire mixture continuously stirred for 30 min. This was followed by the addition of the acrylonitrile (AN) monomer (50 ml) to the mixture and continuously stirred under Ar atmosphere at 85° C. for 3 h to carry out the polymerization reaction. After polymerization, the milky white product was coated on super P/YP-80F, the resulting product was collected and washed with ethanol. The final product was then vacuum dried at 60° C. for 36 h to yield the polyacrylonitrile (PAN) coated super P/YP-80F. Similar procedure can be applicable to any nitrogen containing carbon backbone polymer.

### Preparation of LiOPAN-Coated Super P/YP-80E- Sulfur Composite

The PAN coated super P/YP-80F (10 wt %), elemental sulfur (90 wt %) and lithium nitrate (LiNO₃, 10 wt %) were ground together, then sealed in swage lok cell and heated at 240° C. (with a heating rate of 10° C./min) for 12 h to obtain LiPAN-coated SuperP/YP-80F-S due to vapor phase sulfur infiltration.

### Preparation of Sulfur Cathode

The LiOPAN-S cathode was prepared by mixing LiOPAN-S, Super P/YP-80F, and Poly (vinylidene fluoride) (PVDF) with N-Methyl-2-Pyrrolidone (NMP) acting as a solvent to form a uniform slurry. The weight ratio of active material, Super P, and binder is 70:20:10 (wt. %) and 72:18:10 (wt. %).

The slurry was then coated onto a single side as well as on both sides to form double-sided coatings on a carbon-coated aluminum foil using the doctor-blade technique. The S cathode was then dried at 65° C. in a heated vacuum oven for 18 h with optimized S areal loading of 4-6 mg/ cm² per side. The cathode was then subjected to calendaring process to 80-70% of its original thickness prior to use (i.e. 20-30% calendering). The electrode was then punched to rectangular pieces (50 mm×40 mm) for pouch cell use. The cathode porosity was calculated based on the density of element density of sulfur and carbon. The sulfur electrode thickness varied from 80-140 μm w.r.t S loading given in mg/cm².

### Assembling of Pouch Cell

Single sided 50 mm Li foil was calendered onto a 10 mm Cu foil and punched to rectangular pieces (50.2 mm 40.2 mm) as the Li anode for the single layer pouch cell. The separator for the pouch cell was Celgard 2400. Single-sided S cathode, separator, and single-sided Li anode were stacked as single layer pouch cell. Double-sided 50 μm Li foil was calendered onto a 10 mm Cu foil and punched to rectangular pieces (50.2 mm 40.2 mm) as the Li anode of pouch cell. Double-sided S cathode, separator, and double-sided Li anode were alternatively stacked together with two pieces of single-sided S cathode as the outer layer for the multi-layer pouch cells. The electrolyte used in this study was 1.8 M lithium bis(trifluoromethanesulfonyl)imide (LiTFSI) in 1,3-dioxolane (DOL) and 1,2-dimethoxyethane (DME) with 0.4 M LiNO₃ as an additive and the E/S ratio used 4 μl/mg. The electrolyte injection and pouch cell sealing were carried out in a glovebox. All the pouch cells tested using following constant current protocol: 2 formation cycles with C/20, 3 cycles with C/20, 100 cycles with C/10 and 100 cycles with C/5. More details of the individual electrodes and the performance of the fabricated cells are given in the following examples.

### Example 15

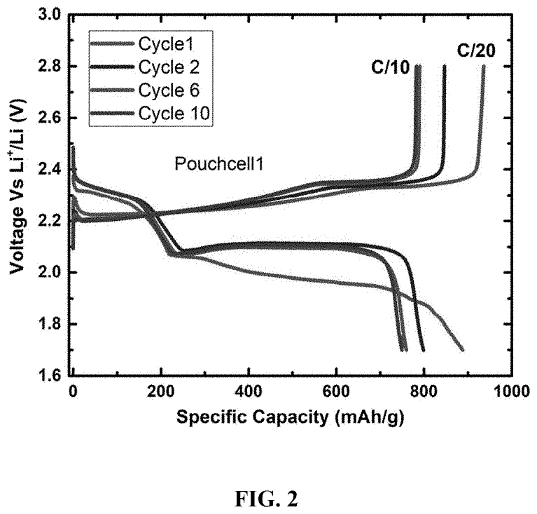

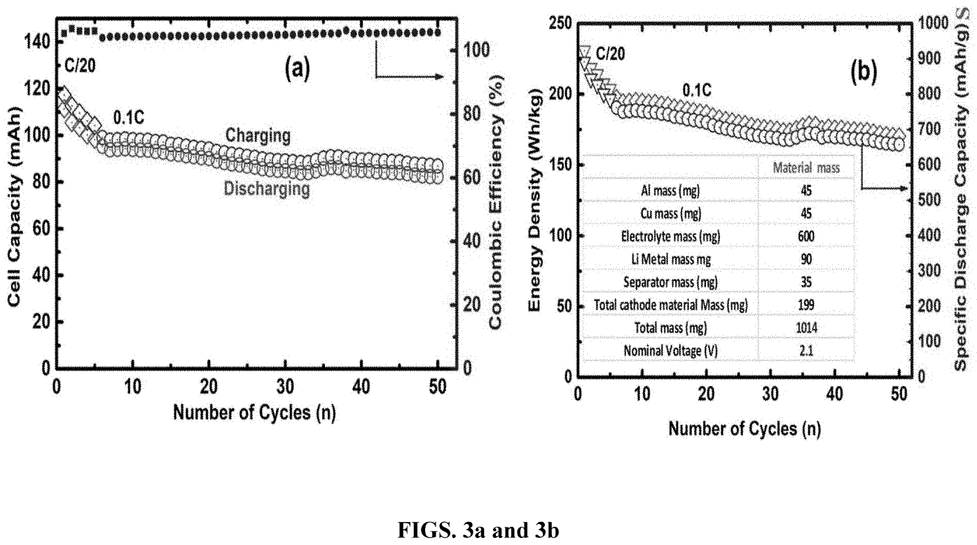

The single layer Li—S pouch cell was fabricated with sulfurized LiOPAN coated Super P: Sulfur composite as S cathode, with S loading 6.26 mg/cm², a cathode porosity of 66.0% and 63.0 wt. % of S content available in the cathode. The amounts of electrolyte and Li anode thickness was strictly controlled at electrolyte (E)/sulfur (S)=4.0 μl/mg and 50 μm, respectively. The first cycle capacity was observed to be 900 mAh/g-S at C/20 rate but the cathode was designed to have a nominal capacity of 1055.25 mAh/g-S (1675 mAh/g-S*0.63), and the observed capacity was indeed very close to the designed nominal capacity. The ideal discharge mechanism of a Li—S battery can be divided into four steps which are clearly delineated in FIG. 2 and described as follows: (i) Reaction of elemental sulfur with lithium. (ii) Reaction between the dissolved polysulfide, Li₂S₈ and lithium. (iii) A transition of the dissolved polysulfide to Li₂S₄, eventually to insoluble Li₂S₂ and finally, Li₂S, (iv) An equilibrium reaction of the insoluble Li₂S₂ to Li₂S. Full cell capacity, Coulombic efficiency and energy density obtained are shown in FIGS. 3a and 3b with respect to cycle number. The full cell capacity stabilized at ≈100 mAh at a current rate of C/10 rate with a reasonably long cycle life of 50 cycles with a capacity fade rate 0.2% per cycle. Full cell energy density observed ≈240 Wh/kg at a current rate of C/20 rate and specific capacity which stabilized at 655 mA/g-S at the end of 50 cycles when cycled at a current rate of C/10 rate.

### Example 16

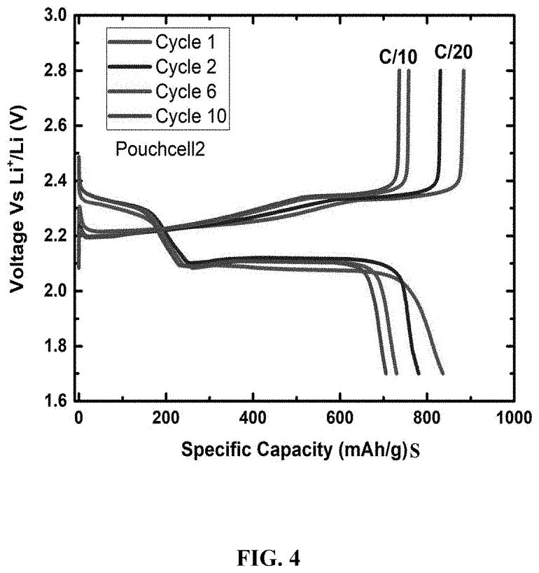

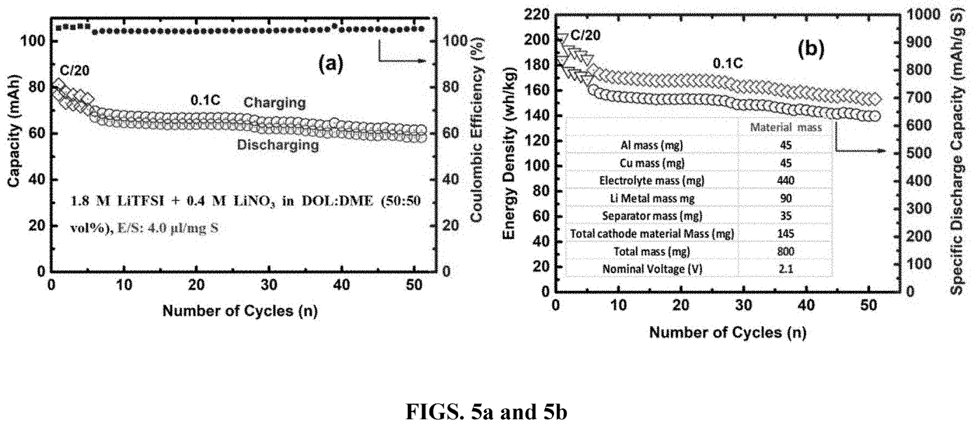

Sulfurized LiOPAN coated Super P: Sulfur composite cathode with a total sulfur loading in the cathode of 4.59 mg/ cm² was used to fabricate the single layer Li—S pouch cell and the data is shown in FIG. 4 and FIGS. 5a and 5b. The S cathode porosity was 70.0% with a thickness of 126 μm. The single layer pouch cell with low loading showed similar results as in Example 14. Hence, the data is reproducible with in the S loading range of 4.0-6.5 mg/cm².

### Example 17

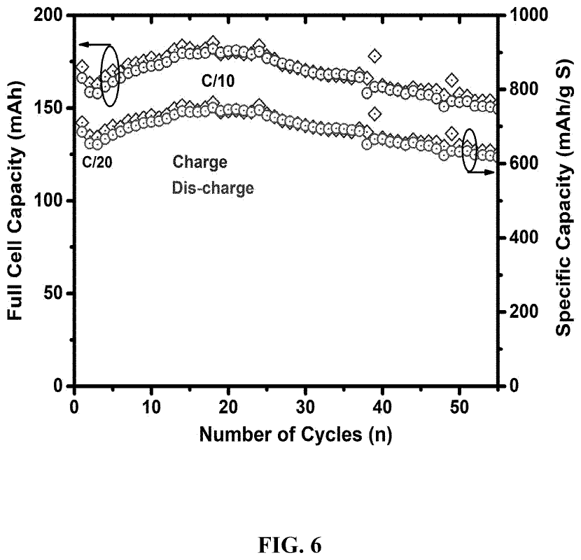

Multi-layer pouch cells were fabricated and tested to observe their charge-discharge cycling in order to further verify the cycling response of sulfurized LiOPAN coated Super P: Sulfur composite as cathode material. Two-layered pouch cell designed to exhibit a nominal capacity ≈200 mAh was fabricated and the cycling data obtained is shown in FIG. 6. The sulfur loading was 6.0 mg/cm² on each sulfur cathode layer with a sulfur content of 63.0 wt. %. The cycling data trend matched with that of Example 15.

### Example 18

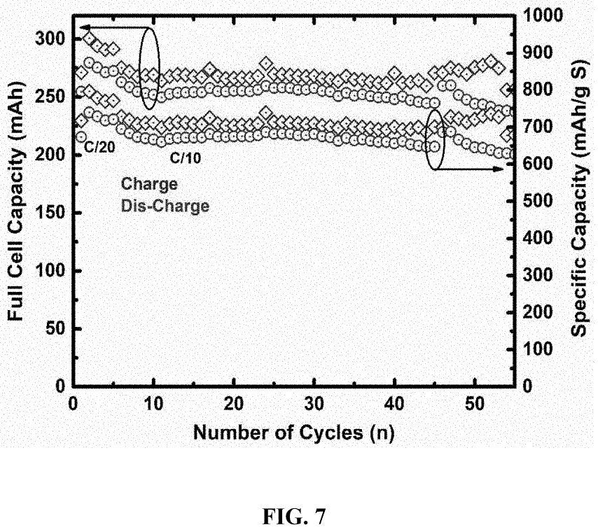

The four layer pouch cell (stacking of multi cells) designed to exhibit full cell capacity of 300 mAh with sulfur loading of 4.72 mg/ cm² on each S cathode was fabricated with sulfur content of 63.0 wt. %. The cycling data shown in FIG. 7.

### Example 19

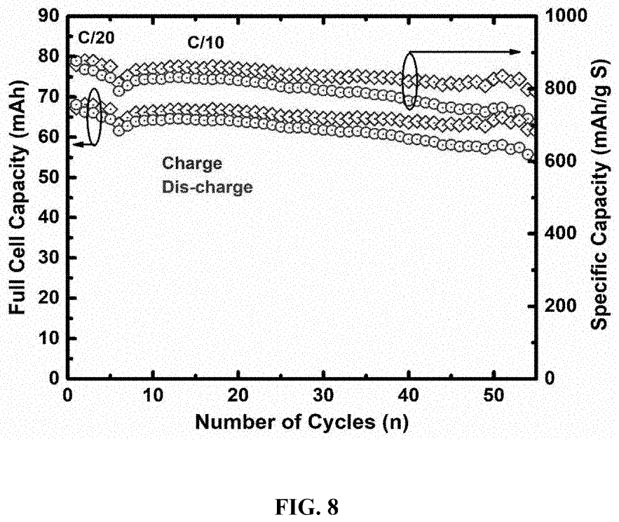

The sulfur cathode LIC-CFM material was also prepared using sulfurized LiOPAN coated on porous YP-80F as the active material with slurry composition of 72 (active material): 18 (super P): 10 (PVDF). The single layer pouch cell was fabricated using 50 μm thick Li metal as anode. The sulfur cathode porosity is 62.0% with a total electrode thickness of 103.0 μm and a sulfur loading of 5.20 mg/cm² without calendaring and with a sulfur content of 64.80 wt. %. The specific capacity stabilized at ≈625 mAh/g-S and the corresponding cycling data shown in FIG. 8.

### Example 20

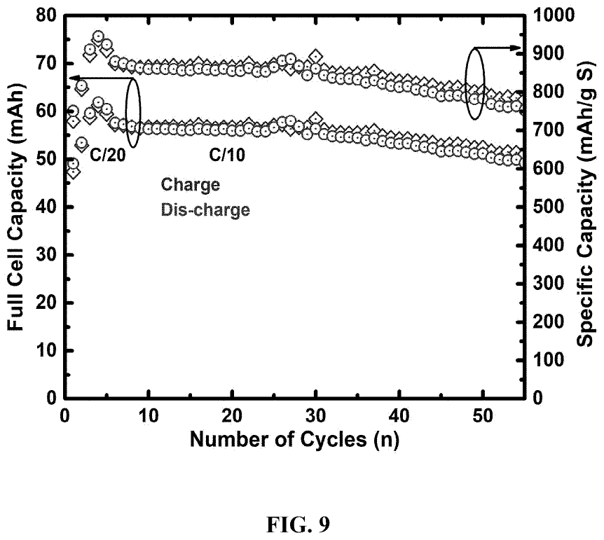

Single layer pouch cell fabricated using calendared S cathode of LIC-CFM comprising sulfurized LiOPAN coated on porous YP-80F as the active material with S loading of 4.8 mg/cm² and S content 64.8 wt. %. The porosity of the S cathode decreased to 56.0% with thickness of 84.0 μm. The cycling data shown in FIG. 9. The cycling results indicate better performance after calendaring exhibiting a stable capacity of ˜630 mAh/g-S.

### Example 21

### Preparation of Hybrid Solid Electrolyte (HSE) (PEO: LiClO₄-LLZO) Coated Celgard Separators

The calculated amounts of polyethylene oxide (PEO) (M_{w}5*10⁶) and LiClO₄ ([EO]:[Li]=15:1) were added to acetonitrile (ACN) and stirred for 24 hours at ambient temperature. To this was added 50 wt. % of Al doped stabilized cubic Li₇La₃Zr₂O₁₂ (LLZO) (Li_{6.25}Al_{0.25}La₃Zr₂O₁₂) with submicron particle size (0.1-0.5 μm) (MSE Supplies, Tucson, Ariz.) to form the PEO: LiClO₄ mixture. The polymer solution and the dispersed LLZO solution were mixed thoroughly for 24 hours at room temperature in order to achieve a homogenous and uniform viscous solution (PEO: LiClO₄—Al-dopedLLZO). The uniform solution was then cast on one side of the Celgard separator as the substrate and then kept at room temperature in a closed chamber to evaporate the ACN solvent. The fully dried HSE coated Celgard separator was then cut into circular discs and was used as the HSE coated separator. The thickness of the HSE film on the Celgard separator varied from 5-20 μm.

The 2032 coin cells were assembled using the sulfurized LiOPAN coated YP-80F:Sulfur composite as the S cathode, HSE coated on one side of the Celgard separator facing the Li anode and Li metal as the anode. The hybrid solid electrolyte was coated on the side of the separator facing the Li anode in order to suppress the polysulfide shuttling effect common in Li—S systems and to correspondingly help improve the cycling and the Coulombic efficiency of the Li—S battery. The liquid electrolyte was also used in the coin cell in addition to the HSE film (1.8 M lithium bis(trifluoromethanesulfonyl) imide (LiTFSI) in 1,3-dioxolane (DOL) and 1,2-dimethoxyethane (DME) with 0.4 M LiNO₃ as an additive to) and the Electrolyte (E)/sulfur (S) ratio used was 4 μl/mg

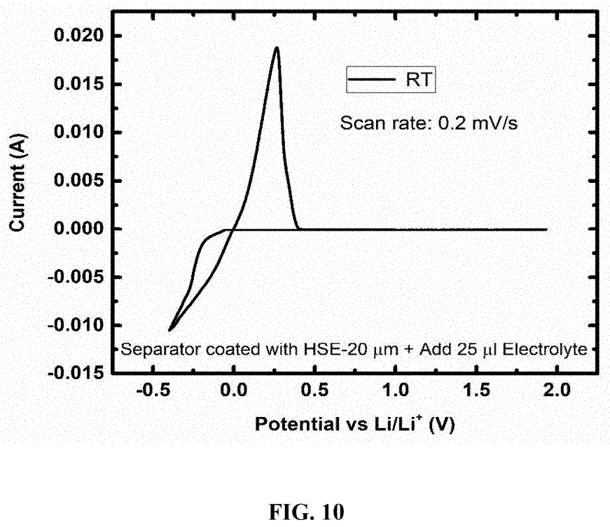

Li plating and de-plating studies shown in FIG. 10, conducted using cyclic voltammetry (CV) on a coin cell at room temperature configuration of: Li metal∥HSE coating+liquid electrolyte∥Cu metal.

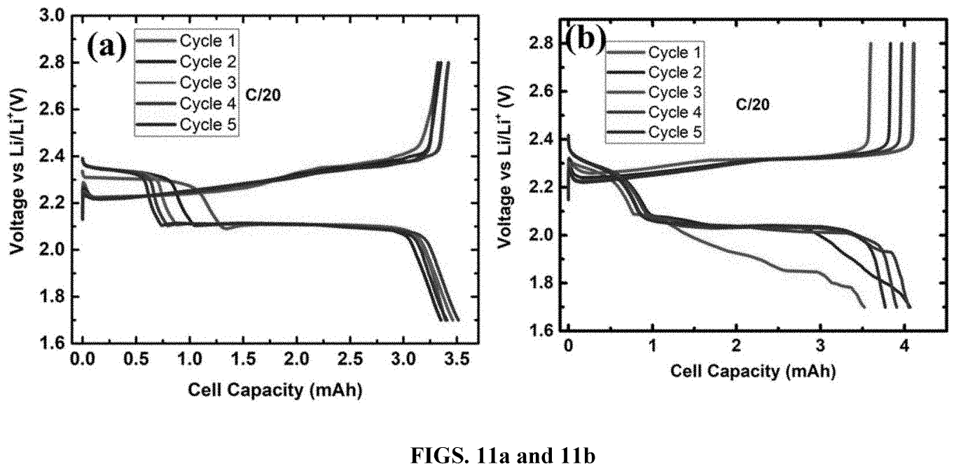

Identical S cathodes used in this study included S loading 4.7 mg/cm², S content 64.8 wt. % and porosity 67%. These electrodes were used for assembling the coin cells. The voltage window stability of Li—S cell is shown in FIGS. 11a and 11b and the Li—S cell with HSE coated separator shows a more stable voltage window than the Li—S cell cycled containing only liquid electrolyte.

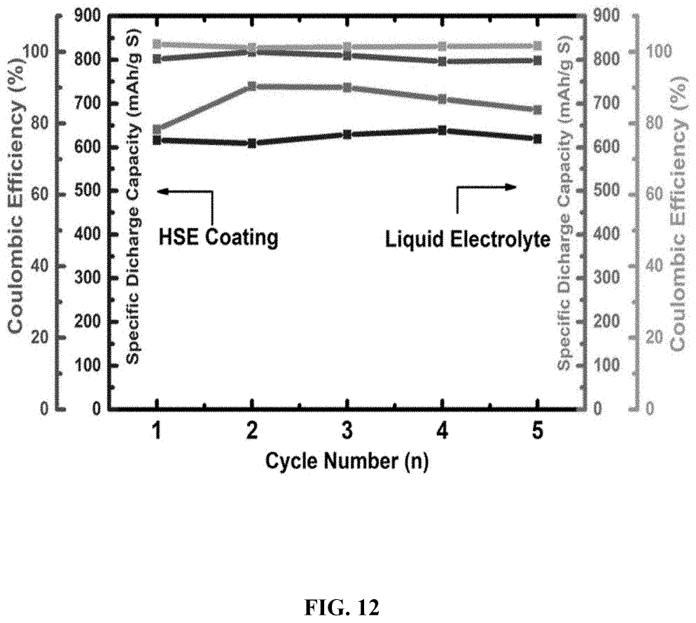

Comparison of the Coulombic efficiency and the specific capacity of the coin cells cycled with the separator coated with the HSE and the coin cell cycled with the liquid electrolyte is shown in FIG. 12. From FIG. 12, it is seen that the Coulombic efficiency is 99% for the HSE coating used Li—S cell. In general, Li—S cells with liquid electrolyte showed a Coulombic efficiency greater than 100% due to side reactions or polysulfide shuttling effect. The HSE coating on the separator facing Li anode demonstrated that the HSE network created by the Al-doped LLZO effectively trapped the soluble polysulfide species and also contributed to control any side reactions thus improving the overall Coulombic efficiency.

We claim:

1. A complex framework material structure, comprising:
a complex framework material host, comprising:
a complex framework material; and
a coating applied to the complex framework material comprising one or more layers comprising a component selected from the group consisting of an electronic conductor, a lithium ion conductor and a functional catalyst.

2. The complex framework material structure of claim 1, wherein the complex framework material is comprised of a porous carbon matrix.

3. The complex framework material structure of claim 1, wherein the complex framework material comprises a carbon material selected from the group consisting of Super P, YP-80F, and mixtures thereof to bind polysulfide via carbon-sulfur linkages.

4. The complex framework material structure of claim 1, wherein the coating is a single layer comprising a component selected from the group consisting of an electronic conductor, a lithium ion conductor and a functional catalyst.

5. The complex framework material structure of claim 1, wherein the coating is a multi-layer coating and each layer comprises a component selected from the group consisting of an electronic conductor, a lithium ion conductor and a functional catalyst.

6. The complex framework material structure of claim 1, wherein sulfur is infiltrated into the complex framework material host.

7. The complex framework material structure of claim 1, wherein the complex framework material structure is selected from the group consisting of EC-CFM, LIC-CFM and FC-CFM.

8. The complex framework material structure of claim 6, wherein the complex framework material structure is selected from the group consisting of EC-CFM-S, LIC-CFM-S, and FC-CFM-S.

9. A lithium-sulfur battery comprising a complex framework material structure-based cathode comprising the complex framework material structure of claim 1.

10. A method of preparing a complex framework material structure, comprising:
forming a complex framework material host, comprising;
providing a complex framework material;
applying a coating to the complex framework material comprising one or more component selected from the group consisting of an electronic conductor, a lithium ion conductor and a functional catalyst; and
infiltrating the complex framework material host with sulfur.

11. A pouch cell, comprising:
a complex framework material/sulfur composite cathode, comprising:
a complex framework material host, comprising:
a complex framework material; and
a coating applied to the complex framework material comprising one or more layers comprising a component selected from the group consisting of an electronic conductor, a lithium ion conductor and a functional catalyst; and
sulfur infiltrated into the complex framework material host;
a separator applied to the complex framework material/sulfur composite cathode; and
a lithium anode applied to the separator,
wherein, the composite complex framework material/sulfur cathode, the separator and the lithium anode are in a stacked configuration.

12. The pouch cell of claim 11, wherein the complex framework material is comprised of a porous carbon matrix.

13. The pouch cell of claim 11, wherein the complex framework material comprises a carbon material selected from the group consisting of Super P, YP-80F and mixtures thereof to bind polysulfide via carbon-sulfur linkages.

14. The pouch cell of claim 11, wherein the pouch cell comprises a single layer of each of the complex framework material/sulfur cathode and the lithium anode.

15. The pouch cell of claim 1, wherein the pouch cell comprises two or more layers of each of the complex framework material/sulfur cathode and the lithium anode.
